(19) United States
(12) Patent Application Publication
(10) Pub. No.: US 2025/0005195 A1
(43) Pub. Date: Jan. 2, 2025

(54) DEVICE MONITORING TO IDENTIFY SAFETY OF A USER

(71) Applicant: Apple Inc., Cupertino, CA (US)

(72) Inventors: Daniel P. Shepard, San Jose, CA (US); Michael P. Dal Santo, San Francisco, CA (US); Ping-Ko Chiu, San Francisco, CA (US); Kumar Gaurav Chhokra, San Mateo, CA (US); Yannick L. Sierra, San Francisco, CA (US); Andrew M. Pace, Gloucestershire (GB); Richard L. Hagy, Montara, CA (US); Lindsey McAllister, San Francisco, CA (US); Dharini Sitaraman, San Jose, CA (US); Andrew N. Khoury, Santa Clara, CA (US); Richard Bower Warren, Redwood City, CA (US); Brent M. Ledvina, San Francisco, CA (US); Siva Ganesh Movva, San Jose, CA (US); Ronald Keryuan Huang, San Jose, CA (US); Robert W. Mayor, Half Moon Bay, CA (US); Stacey F. Lysik, Cupertino, CA (US); Areeba Kamal, San Francisco, CA (US); Ryan D. Shelby, Mountain View, CA (US); Elizabeth Caroline Furches Cranfill, San Francisco, CA (US); Kanika Malhotra, Belmont, CA (US); Gillian T. Verga, Los Gatos, CA (US)

(73) Assignee: Apple Inc., Cupertino, CA (US)

(21) Appl. No.: 18/731,009

(22) Filed: May 31, 2024

Related U.S. Application Data
(60) Provisional application No. 63/470,789, filed on Jun. 2, 2023.
(60) Provisional application No. 63/653,654, filed on May 30, 2024.

(51) Int. Cl. G06F 21/62; G06Q 50/26; H04L 9/32

(52) U.S. Cl. CPC G06F 21/6245; G06Q 50/265; H04L 9/3213

(57) ABSTRACT

Embodiments of the present disclosure are directed to, among other things, monitoring a user device to determine whether a user associated with the device is safe. In some examples, a user (which may be referred to herein as an “initiator” establishes a device monitoring session (which may be referred to herein as “session”) with a user, or a group of users, so that the user(s) are notified either when the initiator has safely ended the device monitoring session or receives access to session data that was collected during the session. In some configurations, the session can be handed off from a first user device that is currently active to a different user device. Instead of the first user device always being the device that interacts with the server, a different first user device may be selected as the active device to interact with the server.

### CROSS-REFERENCES TO OTHER APPLICATIONS

This application claims priority to U.S. Provisional Application No. 63/470,789, for “DEVICE MONITORING TO IDENTIFY SAFETY OF A USER” filed on Jun. 2, 2023, and U.S. Provisional Application No. 63/653,654 for “DEVICE MONITORING TO IDENTIFY SAFETY OF A USER” filed on May 30, 2024, which is herein incorporated by reference in its entirety for all purposes.

### BACKGROUND

Software applications can be utilized to provide a plethora of different types of functions and information to users. Today, many software applications purport to help a user stay more organized, manage everyday tasks, perform route planning, and even allow a user to share their location with other users. Sharing location data with other users, however, exposes personal data to the other users.

### BRIEF SUMMARY

Embodiments of the present disclosure can provide systems, methods, and computer-readable media (collectively, techniques) for monitoring a user device to determine whether a user associated with the device is safe.

In some embodiments, computer-implemented methods are disclosed. A method may comprise receiving, from a first user device, an indication to start a device monitoring session; sending, to a second user device, a first message that indicates a start of the device monitoring session; gathering session data at different times throughout the device monitoring session, wherein the session data includes location data and other device data associated with the first user device; generating, using a key associated with the first user device, encrypted session data from the session data; storing the encrypted session data within a secure storage service that is separate from the first user device and the second user device; monitoring, during the device monitoring session, the first user device to identify an occurrence of one or more events, wherein the one or more events include at least one of an end session event, a check-in event, or an anomaly event; and performing one or more actions, based at least in part on the occurrence of the one or more events, wherein the one or more actions include at least one of an end session action that sends an end session message to the second user device that the session completed successfully, a check-in action that sends a check-in message to the first user device that requests an indication to continue or end the device monitoring session, or a release session data action that includes sending a release session data message to the second user device indicating that the second user device is authorized to access the encrypted session data from the secure storage service.

A method may also comprise receiving, from a first user device, an indication to start a device monitoring session to monitor the first user device between a starting location and a destination; determining, by one or more processors, an estimated travel time to reach the destination from the starting location; determining, by the one or more processors, a check-in time threshold based at least in part on an initial time at the start of the device monitoring session and the estimated travel time; gathering, by the one or more processors, session data, at different times during the device monitoring session, wherein the session data includes location data associated with a first user device; and performing, by the one or more processors, one or more actions based at least in part on at least one of the destination, the estimated travel time, the check-in time threshold, or the session data, wherein the one or more actions include at least one of a check-in update action, or an anomaly action that indicates a concern associated with the first user device/

A method may comprise receiving, from a first user device, an indication to start a device monitoring session; sending, to group member devices associated with a group, a first group message that indicates a start of the device monitoring session; gathering session data during the device monitoring session, wherein the session data comprises at least location data and is gathered from an active device selected from the first user device or one or more other first user devices; and performing one or more actions based at least in part on an occurrence of the one or more events, wherein the one or more actions include providing varying access to one or more of group messages associated with the device monitoring session or the session data to different group member devices.

A method may also comprise receiving, from a first user device of one or more first user devices, an indication to start a device monitoring session; gathering, from an active device of the one or more first user devices, session data during the device monitoring session, wherein the session data comprises at least location data; monitoring, during the device monitoring session, at least the active device, to identify an occurrence of one or more events; determining an occurrence of a handoff event associated with the active device; and designating, based at least in part on determining the occurrence of the handoff event, a different one of the one or more first user devices as the active device.

In some embodiments, computing devices are disclosed. The computing device may comprise a memory configured to store computer-executable instructions and a processor configured to access the memory and execute the computer-executable instructions to perform operations. The operations may comprise receiving, from a first user device, an indication to start a device monitoring session; sending, to a second user device, a first message that indicates a start of the device monitoring session; gathering session data at different times throughout the device monitoring session, wherein the session data includes location data and other device data associated with the first user device; generating, using a key associated with the first user device, encrypted session data from the session data; storing the encrypted session data within a secure storage service that is separate from the first user device and the second user device; monitoring, during the device monitoring session, the first user device to identify an occurrence of one or more events, wherein the one or more events include at least one of an end session event, a check-in event, or an anomaly event; and performing one or more actions, based at least in part on the occurrence of the one or more events, wherein the one or more actions include at least one of an end session action that sends an end session message to the second user device that the session completed successfully, a check-in action that sends a check-in message to the first user device that requests an indication to continue or end the device monitoring session, or a release session data action that includes sending a release session data message to the second user device indicating that the second user device is authorized to access the encrypted session data from the secure storage service.

The computing device may also comprise receiving, from a first user device, an indication to start a device monitoring session to monitor the first user device between a starting location and a destination; determining, by one or more processors, an estimated travel time to reach the destination from the starting location; determining, by the one or more processors, a check-in time threshold based at least in part on an initial time at the start of the device monitoring session and the estimated travel time; gathering, by the one or more processors, session data, at different times during the device monitoring session, wherein the session data includes location data associated with a first user device; and performing, by the one or more processors, one or more actions based at least in part on at least one of the destination, the estimated travel time, the check-in time threshold, or the session data, wherein the one or more actions include at least one of a check-in update action, or an anomaly action that indicates a concern associated with the first user device/

The computing device may also comprise receiving, from a first user device, an indication to start a device monitoring session; sending, to group member devices associated with a group, a first group message that indicates a start of the device monitoring session; gathering session data during the device monitoring session, wherein the session data comprises at least location data and is gathered from an active device selected from the first user device or one or more other first user devices; and performing one or more actions based at least in part on an occurrence of the one or more events, wherein the one or more actions include providing varying access to one or more of group messages associated with the device monitoring session or the session data to different group member devices.

The computing device may also comprise receiving, from a first user device of one or more first user devices, an indication to start a device monitoring session; gathering, from an active device of the one or more first user devices, session data during the device monitoring session, wherein the session data comprises at least location data; monitoring, during the device monitoring session, at least the active device, to identify an occurrence of one or more events; determining an occurrence of a handoff event associated with the active device; and designating, based at least in part on determining the occurrence of the handoff event, a different one of the one or more first user devices as the active device.

In some embodiments, computer-readable storage mediums are disclosed. The computer-readable storage medium may store computer-executable instructions that, when executed by one or more processors of a computing device, configure the one or more processors to perform operations. The operations may comprise receiving, from a first user device, an indication to start a device monitoring session; sending, to a second user device, a first message that indicates a start of the device monitoring session; gathering session data at different times throughout the device monitoring session, wherein the session data includes location data and other device data associated with the first user device; generating, using a key associated with the first user device, encrypted session data from the session data; storing the encrypted session data within a secure storage service that is separate from the first user device and the second user device; monitoring, during the device monitoring session, the first user device to identify an occurrence of one or more events, wherein the one or more events include at least one of an end session event, a check-in event, or an anomaly event; and performing one or more actions, based at least in part on the occurrence of the one or more events, wherein the one or more actions include at least one of an end session action that sends an end session message to the second user device that the session completed successfully, a check-in action that sends a check-in message to the first user device that requests an indication to continue or end the device monitoring session, or a release session data action that includes sending a release session data message to the second user device indicating that the second user device is authorized to access the encrypted session data from the secure storage service.

The computer-readable storage medium may also store computer-executable instructions that, when executed by one or more processors of a computing device, configure the one or more processors to perform operations. The operations may comprise receiving, from a first user device, an indication to start a device monitoring session to monitor the first user device between a starting location and a destination; determining, by one or more processors, an estimated travel time to reach the destination from the starting location; determining, by the one or more processors, a check-in time threshold based at least in part on an initial time at the start of the device monitoring session and the estimated travel time; gathering, by the one or more processors, session data, at different times during the device monitoring session, wherein the session data includes location data associated with a first user device; and performing, by the one or more processors, one or more actions based at least in part on at least one of the destination, the estimated travel time, the check-in time threshold, or the session data, wherein the one or more actions include at least one of a check-in update action, or an anomaly action that indicates a concern associated with the first user device/

The computer-readable storage medium may also store computer-executable instructions that, when executed by one or more processors of a computing device, configure the one or more processors to perform operations. The operations may comprise receiving, from a first user device, an indication to start a device monitoring session; sending, to group member devices associated with a group, a first group message that indicates a start of the device monitoring session; gathering session data during the device monitoring session, wherein the session data comprises at least location data and is gathered from an active device selected from the first user device or one or more other first user devices; and performing one or more actions based at least in part on an occurrence of the one or more events, wherein the one or more actions include providing varying access to one or more of group messages associated with the device monitoring session or the session data to different group member devices.

The computer-readable storage medium may also store computer-executable instructions that, when executed by one or more processors of a computing device, configure the one or more processors to perform operations. The operations may comprise receiving, from a first user device of one or more first user devices, an indication to start a device monitoring session; gathering, from an active device of the one or more first user devices, session data during the device monitoring session, wherein the session data comprises at least location data; monitoring, during the device monitoring session, at least the active device, to identify an occurrence of one or more events; determining an occurrence of a handoff event associated with the active device; and designating, based at least in part on determining the occurrence of the handoff event, a different one of the one or more first user devices as the active device

The computer-readable storage medium may also store computer-executable instructions that, when executed by one or more processors of a computing device, configure the one or more processors to perform operations. The operations may comprise receiving, from a first user device of one or more first user devices, an indication to start a device monitoring session; gathering, from an active device of the one or more first user devices, session data during the device monitoring session, wherein the session data comprises at least location data; monitoring, during the device monitoring session, at least the active device, to identify an occurrence of one or more events; determining an occurrence of a handoff event associated with the active device; and designating, based at least in part on determining the occurrence of the handoff event, a different one of the one or more first user devices as the active device.

### BRIEF DESCRIPTION OF THE DRAWINGS

FIG. 1 is a block diagram of an example environment for implementing the disclosed techniques, according to some embodiments.

FIG. 2 is a block diagram of an example environment for implementing the disclosed techniques, according to some embodiments.

FIG. 3 is a block diagram of an example environment for implementing the disclosed techniques, according to some embodiments.

FIG. 4 is a block diagram of an example user interface for implementing the disclosed techniques, according to some embodiments.

FIG. 5 is a flow diagram that details a process for implementing the disclosed techniques, according to some embodiments.

FIG. 6 is a flow diagram that details a process for implementing the disclosed techniques, according to some embodiments.

FIG. 7 is a flow diagram that details a process for implementing the disclosed techniques, according to some embodiments.

FIG. 8 is a flow diagram that details a process for implementing the disclosed techniques, according to some embodiments.

FIG. 9 is a flow diagram that details a process for implementing the disclosed techniques, according to some embodiments.

FIG. 10 is a flow diagram that details a process for implementing the disclosed techniques, according to some embodiments.

FIG. 11 is a flow diagram that details a process for implementing the disclosed techniques, according to some embodiments.

FIG. 12 is a flow diagram that details a process for implementing the disclosed techniques, according to some embodiments.

FIG. 13 is a flow diagram that details a process for implementing the disclosed techniques, according to some embodiments.

FIG. 14 is a flow diagram that details a process for implementing the disclosed techniques, according to some embodiments.

FIG. 15 is a flow diagram that details a process for implementing the disclosed techniques, according to some embodiments.

FIG. 16 is a flow diagram that details a process for implementing the disclosed techniques, according to some embodiments.

FIG. 17 is a flow diagram that details a process for implementing the disclosed techniques, according to some embodiments.

FIG. 18 is a flow diagram that details a process for implementing the disclosed techniques, according to some embodiments.

FIG. 19 is a flow diagram that details a process for implementing the disclosed techniques, according to some embodiments.

FIG. 21 is a block diagram of an example device for implementing the disclosed techniques, according to some embodiments.

FIG. 22 is a block diagram of an example system for implementing the disclosed techniques, according to some embodiments.

FIG. 23 is a flow diagram that details a process for implementing the disclosed techniques, according to some embodiments.

FIG. 24 is a flow diagram that details a process for implementing the disclosed techniques, according to some embodiments.

### DETAILED DESCRIPTION

In the following description, various embodiments will be described. For purposes of explanation, specific configurations and details are set forth to provide a thorough understanding of the embodiments. However, it will also be apparent to one skilled in the art that the embodiments may be practiced without the specific details. Furthermore, well-known features may be omitted or simplified in order not to obscure the embodiment being described.

Embodiments of the present disclosure are directed to, among other things, monitoring a user device to determine whether a user associated with the device is safe. In some examples, a user (“initiator”) establishes a device monitoring session (which may be referred to herein as a “session”) with a user (“receiver”), or a group of users (“receivers”). The receiver(s) are notified either when the initiator a) has safely ended the session or b) receives access to session data that was collected during the session when the session is determined to not end safely, or some other anomaly has occurred during the monitoring session. In some examples, “session data” includes location data (e.g., GPS data, . . . ) and device data (e.g., usage data, battery level, connectivity status, . . . ) that are associated with the user device of the initiator. In other examples, the session data may include other data associated with the session. Instead of allowing the designated receivers (or any other user or device) to access the session data during the session, session data is not shared with the receiver(s) unless an anomaly (indicating that the initiator may be in danger) occurs during the session that triggers the release of the session data.

To start a session, the initiator may select a UI element on a screen of a device, and specify a few parameters, such as the type of device monitoring session (e.g., time-based, location-based, workout-based, . . . ), information identifying the receiver, a time to end the session when time-based, the ending location to end the session when location-based, and the like. In other examples, a device monitoring session can be started using an electronic message. For instance, the user may specify within the subject of the message, or within the message body, to start a device monitoring session (e.g., using a keyword/keywords) with one or more other users. In other examples, a device monitoring session may automatically be started. For example, a user may specify to start a device monitoring session based on one or more parameters (e.g., every workout that is a run, drives that occur after/before a specified time, traveling to a specific location, and the like).

The user may also specify the one or more receivers to be included within the device monitoring session. For example, the user may select a single user to be a receiver, or a group of users to be receiver using a user interface. In some configurations, the user selects/specifies a telephone number, a text number, or some other indicator that specifies the users. As will be discussed in more detail below, when a group of users is created, the initiator and/or any of the current users in the group can change the group by adding another user or deleting a user. The term “currently active users” refers to the users/recipients that are currently part of the group.

After specifying parameters associated with the device monitoring session, the device monitoring session is started and the receiver(s) are notified (e.g., via a message or some other type of notification) that the session with the initiator has been started and information about the session. When the device monitoring session includes a group of receivers, each of the group members receives a message/notification. The message can be received in a messaging application that lets the receiver know that the initiator has started a session, and that the receiver will be sent a message when the session has successfully ended or receive a message that authorizes the receiver to access the session data when the session did not successfully end. In other examples, another user that is authorized by the user associated with the device(s) being monitored may start a session. For example, if a first user authorizes another user to start a device monitoring session on their behalf, the second user can perform the actions to start the device monitoring session for the first user.

In a location-based monitoring session, a monitoring service may determine that the user device associated with the user has safely reached the specified destination. In some examples, a geofence may be used to help ensure that a user device of the initiator has successfully arrived at the specified destination. As will be described in more detail below, in some cases, a handoff may occur between a first device associated with the user to a second device associated with the user. For example, a handoff may be performed by the currently active device to a second device that the user currently has with them in response to detection of a handoff event (e.g., based on battery levels, wireless connection strengths, cellular network connectivity parameters, . . . ). More information is provided below.

In the case, when the monitoring service identifies that the session has safely ended, a message is automatically sent (e.g., by a messaging service) to one or more user devices associated with the one or more receivers indicating that the initiator safely arrived at the destination. Similarly, in a time-based session, the receiver(s) are notified when the initiator confirms that the session has safely ended. In a workout-based session, the receiver(s) are notified when the workout has safely ended. According to some configurations, only the active receiver(s) receive a message. For instance, if the group initially starts with five receivers, and three of the receivers have been removed from the group, then only the two remaining receivers will receive the message. The receivers that are currently within the group may be referred to herein as “active receivers”.

In examples where the device monitoring session detects an anomaly during the session that triggers the release of the session data, the active receivers can access session data that has been gathered during the session. An anomaly may be any information that indicates that a problem has been detected during the session. In some examples, the information used in determining an anomaly may be data indicating that the initiator has been involved in a crash, has made an emergency call, has not checked-in for a specified period of time, has not made progress toward a destination, has been moving away from a specified destination for some period of time, has not finished a workout, and the like. Depending on the anomaly, the monitoring service may attempt to check-in with the initiator to determine whether everything is alright with them and/or may determine that the anomaly is a triggering event that authorizes the release session data to the active receivers.

According to some examples, the session data is collected throughout the session (e.g., every minute, five minutes, ten minutes, . . . ), encrypted using a cryptographic key associated with the initiator, and stored within a secure data store. In some examples, the session data is stored in a secure data store that is physically separate from the user device, such as in a cloud storage service. According to some configurations, the session data is protected from release until a triggering event authorizes the release to the active receivers. In this way, the initiator does not have to maintain network connectivity at the time of a triggering event in order for the session data to be released. In some examples, the session data for a session may be collected from more than one device associated with the user. For instance, a first portion of the session data may be collected a first device of the user, and a second portion of the session data may be collected from a second device of the user.

In some examples, the release of the session data may be delayed for some period (e.g., two hours, twenty minutes, one hour, . . . ). For instance, if the user device of the initiator, does not check-in within two hours with the monitoring service, the monitoring service will automatically send a message to the user device associated with each of the active receivers that identifies how to access the escrowed session data, and that the user device of the initiator is no longer sending updates. According to some configurations, the check-in may be a confirmation received from the initiator to continue the session and/or based on data (e.g., location data and/or device data) that indicates that the user device of the initiator is still making progress toward the destination, and/or the initiator is actively using the user device, and the like. In some examples, the message can be re-scheduled for delivery to the active receivers at each check-in. For instance, the monitoring service may re-schedule the release of the session data to two hours later (or some other time) each time the check-in determination is successful.

The message that is sent to the active receivers that authorizes the release of session data can include a token to access the session data within the secure data store, and/or the cryptographic key used to decrypt the session data. In some examples, when the user device of the initiator remains online during the triggering event, the message includes the token to access the session data and the key to decrypt the session data. In other examples, when the user device is offline during the triggering event, the message includes the key but not the token. In this scenario, the secure data storage may be configured to release the session data after a predetermined time. To further enhance the security of the session data, the messages sent between the initiator and the active receivers may be end-to-end encrypted.

In some instances, a monitoring session can be recommended/suggested to the initiator based at least in part on activity and/or interaction of the initiator. For example, using natural language processing (NLP), the device monitoring application (or a daemon running via the OS) can detect text or actions of the user, and use techniques (e.g., machine learning) to determine that a device monitoring session with the receiver would be helpful. In this case, a suggestion may be generated automatically and be presented to the initiator, where the initiator can then edit and/or accept the suggestion.

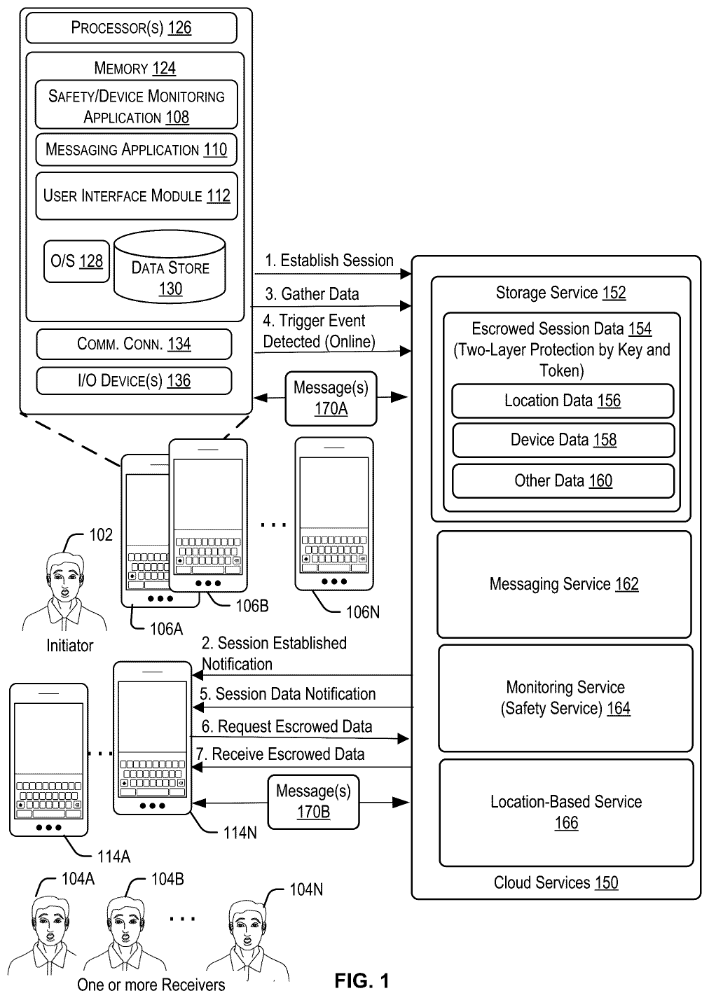

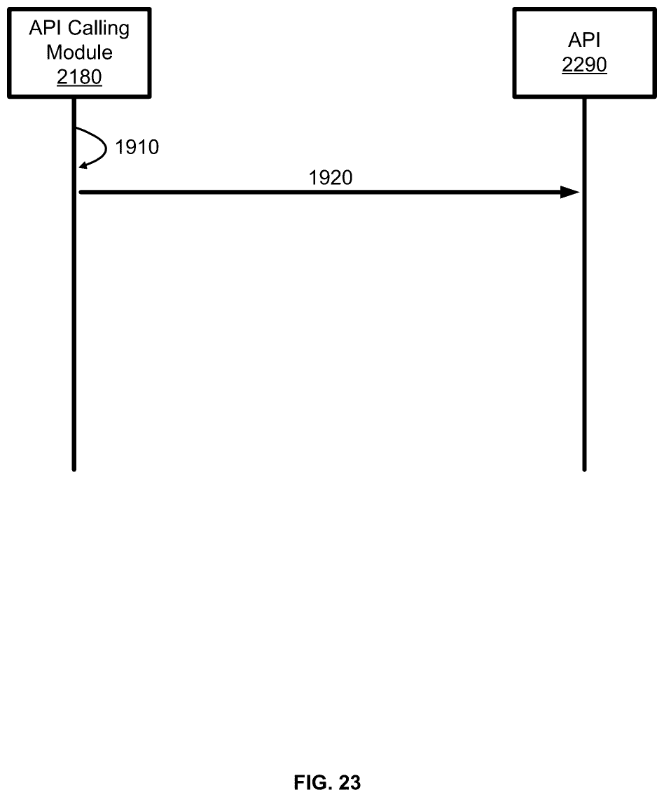

Such concepts will be discussed further below with respect to at least FIGS. 1-24.

FIG. 1 depicts a block diagram of an example environment 100 for implementing the disclosed techniques, according to some embodiments. The environment 100 may include one or more first user devices 106A-106N of a user 102 (the “initiator”), and one or more others user devices 114A-114N associated with one or more of other users 104A-104N (the “receivers”), where the first user devices 106A-106N and the other user devices 114A-114N are any user device (e.g., a mobile phone, a tablet, a wearable device such as a smart watch, etc.).

In some examples, the user 102 may utilize one of the first user devices 106, such as device 106A, to configure a device monitoring session. Each of the devices 106A-106N and the devices 114A-114N may include one or more applications that may be used during a device monitoring session. For example, the user devices 106A-106N and the other user devices 114A-114N may be configured with a messaging application module 110 and a safety/device monitoring application module 108. Even though FIG. 1 illustrates the application modules 108, and 110 as part of the user device 106A, it should be understood that the same or similar applications/modules can be executed by the devices 106B-106N and 114A-114N as well.

Additionally, in some examples, the application module 108 may be configured to execute program code for implementing one or more other software modules (e.g., a user interface module 112. In some cases, the application module 108 may be configured to implement functionality associated with the device monitoring session described herein, including presenting an application user interface (UI), within which the UI elements described herein can be presented. Additionally, in some examples, the UI module 112 can be configured for generated and/or presenting the UIs described herein, including the application UI itself and/or the various UI elements.

In at least one example, the user interface module 112 may be configured to present a wearable device UI that includes one or more UI elements associated with a device monitoring session. Additionally, the UI module 112 may also be configured to present a “quick bar” that can enable quick configuration/customization of a device monitoring session. For example, the quick bar can provide configuration functionality for both a time-based monitoring session, a destination-based monitoring session, a workout monitoring session, or some other type of session. In some examples, the quick bar can include a time UI element (to specify one or more times), a location UI element (to specify a destination), and a receiver UI element (to specify one or more receivers). For example, the receiver UI element may be used to select a group of users to include in a device monitoring session, or a single user. If the user 102 selects the time UI element, the user 102 can quickly select from one or more time configuration options (e.g., when the monitoring session should end). If the user 102 selects the location UI element, the user 102 can quickly select from one or more location configuration options (e.g., the location where the user is planning to go).

In one illustrative configuration, the user devices 106A-106N and 114A-114N may include at least one memory 124 and one or more processing units (or processor(s) 126). The processor(s) 126 may be implemented as appropriate in hardware, computer-executable instructions, firmware, or combinations thereof. Computer-executable instruction or firmware implementations of the processor(s) 126 may include computer-executable or machine-executable instructions written in any suitable programming language to perform the various functions described.

The memory 124 may store program instructions that are loadable and executable on the processor(s) 126, as well as data generated during the execution of these programs. The memory 124 may include an operating system 128, one or more data stores 130, and/or one or more application programs, modules, or services (e.g., applications 108, and 110) for implementing the features disclosed herein with respect to the figures. In some embodiments, the applications may include the safety/device monitoring application module 108 and a messaging application module 110. Depending on the configuration and type of user computing device, the memory 124 may be volatile (such as random-access memory (RAM)) and/or non-volatile (such as read-only memory (ROM), flash memory, etc.). The user devices 106A-106N may also include additional removable storage and/or non-removable storage including, but not limited to, magnetic storage, optical disks, and/or tape storage. The disk drives and their associated computer-readable media may provide non-volatile storage of computer-readable instructions, data structures, program modules, and other data for the computing devices. In some implementations, the memory 124 may include multiple different types of memory, such as static random-access memory (SRAM), dynamic random-access memory (DRAM), or ROM.

The memory 124 and additional storage, both removable and non-removable, are all examples of computer-readable storage media. For example, computer-readable storage media may include volatile or non-volatile, removable or non-removable media implemented in any method or technology for storage of information such as computer-readable instructions, data structures, program modules, or other data. The memory 124 and additional storage are examples of computer storage media. Additional types of computer storage media that may be present in the user devices 106A-106N may include, but are not limited to, PRAM, SRAM, DRAM, RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and which can be accessed by the respective provider computers. Combinations of any of the above should also be included within the scope of computer-readable media.

Alternatively, computer-readable communication media may include computer-readable instructions, program modules, or other data transmitted within a data signal, such as a carrier wave, or other transmission. However, as used herein, computer-readable storage media does not include computer-readable communication media.

The user devices 106A-106N may also contain communications connection(s) 134. The communication connection(s) 134 may allow the user devices 106A-106N to communicate with a stored database, another user device or server, user terminals and/or other devices on one or more networks. For example, the devices 106A-106N may communicate with services and other functionality provided by cloud services 150. The user devices 106A-106N may also include I/O device(s) 136. The I/O device(s) 136 may include devices such as a keyboard, a mouse, a pen, a voice input device, a touch input device, a display, speakers, a printer, etc.

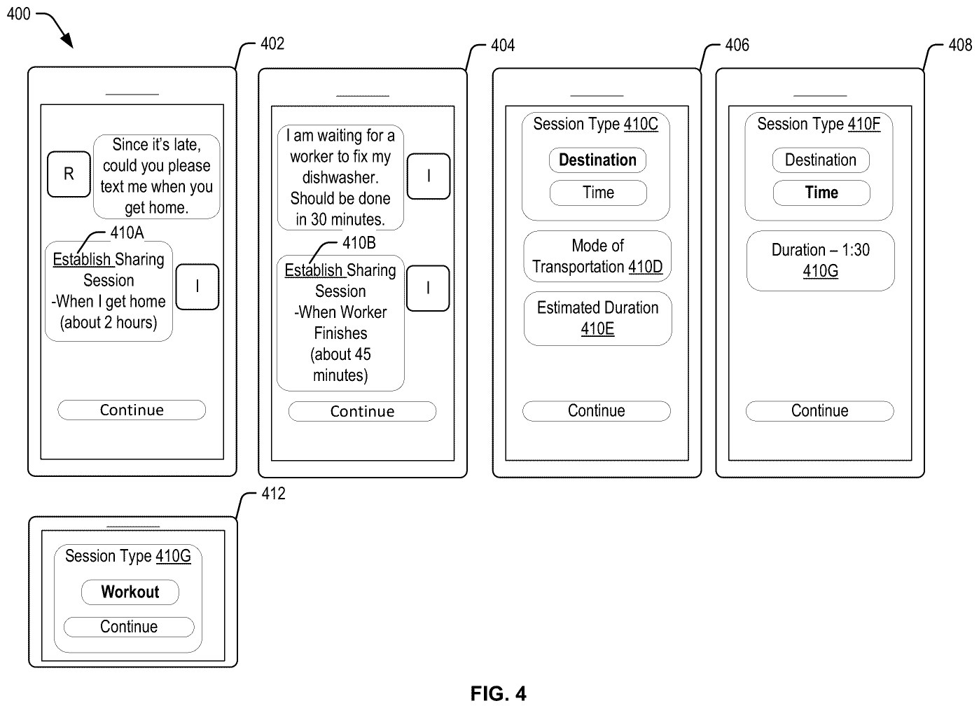

As illustrated in FIG. 1, the initiator uses user device 106A to configure and establish a monitoring session with one or more of the user devices 114A-114N associated with the associated one or more receivers 104A-104N. As briefly discussed above, the initiator may establish a location-based session, a time-based session, or a workout session with a single receiver or a group of receivers. To start a session, the initiator may select a UI element (such as shown in FIG. 4) and specify a few parameters, such as the type of device monitoring session (e.g., time-based, location-based, workout based), information identifying the receiver(s) to be included in the device monitoring session, a time to end the session when time-based, the ending location to end the session when location-based, and the like.

After specifying the parameters, a notification is sent to the selected one or more receivers 104 indicating that the session with the initiator 102 has been started and information about the session. As an example, when receiver 104A and 104C are selected to be included in a group, the receiver 104A and the receiver 104C may receive a message 170B from a messaging application 110 that lets them know that the initiator 102 has started a location-based session and is heading to a specified destination (e.g., home, work, . . . ), and that the receiver 104A and receiver 104C will be sent a message when the session has successfully ended or receive a message that authorizes the receiver 104 to access session data 154 that is securely stored by storage service 152 when the session did not successfully end.

As discussed briefly above, during a device monitoring session, the monitoring service 164 may gather session data throughout the session (e.g., every minute, five minutes, ten minutes, . . . ). In some examples, the monitoring service 164 obtains data from the location-based service 166. The monitoring service 164 may also gather device data associated with the user device 106A and/or some other user device associated with the user 102. For example, a first user device 106A may provide a first portion of the session data while it is the currently active device, and a second device, such as device 106S (not shown) may provide a second portion of the session data while it is the currently active device. As used herein, the term “currently active device” refers to the first user device (e.g., one of devices 106A-106N) that is being monitored and providing the session data. More details regarding handing off the monitoring from a currently active device to another one of the first user devices 106A-106N are provided below.

After gathering the session data 154, the session data 154 is stored/escrowed in a secure storage service 152. According to some configurations, the session data 154 is stored using two-layers of protection that can include a token (or some other security mechanism) as well as being encrypted using a cryptographic key associated with the initiator. As discussed in more detail below, the session data 154 is protected from release until a triggering event authorizes the release to the receiver. In this way, the initiator 102 does not have to maintain network connectivity with the monitoring service 164 and/or the storage service 152 at the time of a triggering event for the session data 154 to be released.

In a location-based monitoring session, a monitoring service 164 may determine that the currently active device of the first user devices 106A-106N, associated with the initiator has safely reached the specified destination. In some examples, a geofence may be used to help ensure that a user device, such as the currently active device, of the initiator has successfully arrived at the specified destination. For purposes of explanation, assume that user device 106A is the currently active devices. In some examples, the monitoring service 164 may interact with one or more services, such as location-based service 166 to identify when the user device 106A has reached the destination, and/or to obtain location data 156 that is stored within the storage service 152. When the monitoring service identifies that the session has safely ended, a message is automatically sent (e.g., by a messaging service) to a user device of the receiver indicating that the initiator safely arrived at the destination. Similarly, in a time-based session, the receiver is notified when the initiator confirms that the session has safely ended.

In examples where the monitoring service 164 detects an anomaly during the session that triggers the release of the session data, the receiver 104 can access the session data 154 from the storage service 152. As discussed briefly above, an anomaly may be any information that indicates that a problem has been detected during the session. This information may be data indicating that the initiator has been involved in a crash, has made an emergency call, has not checked-in for a specified period, has not made progress toward a destination, has been moving in the wrong direction for some period of time, and the like. The monitoring service 164 may also obtain device data from the user device 106A that indicates a use of the user device 106A. For example, the monitoring service 164 may identify that the initiator has unlocked their device (e.g., using a face ID, keycode input, or some other technique) indicating that the user device 106A is being used. The monitoring service 164 may use this as a check-in, and re-schedule delivery of the message to a later time. In other examples, the monitoring service 164 may obtain data indicating that the initiator 102 has been involved in a crash, has made an emergency call, has not checked-in for a specified period, and the like.

In some examples, during a destination-based monitoring session, the monitoring service 164 may calculate (or interact with the location-based service 166 or some other service/application/component) an estimated travel time for the user device 106A to reach the destination from a current location. The monitoring service 164 may also be configured to determine a straight-line distance from the current location to the destination. According to some embodiments, the monitoring service 164 may determine an anomaly based at least in part on determining that the user device 106A is moving away from the destination for some period (e.g., 10 minutes, 20 minutes, . . . ) and/or is not getting closer to the destination.

In some instances, the monitoring service 164 may perform a check-in (e.g., provide a notification that requests a response from the initiator 102) with the initiator to determine whether to end a session (e.g., a time-based session), or whether to continue a session (e.g., have not received data indicating that the user device 106A is progressing toward a destination. When this check-in data is not received by the monitoring service 164 for some period (e.g., 30 minutes, an hour, two hours, . . . ), the monitoring service 164 may cause a triggering event that authorizes the release session data to the receiver.

In some examples, the release of the session data 154 may be delayed for some period (e.g., two hours, twenty minutes, one hour, . . . ). For instance, if the initiator 102 does not check-in within two hours, the monitoring service 164 will automatically send a message (e.g., using messaging service 162) to the one or more receiver devices that are still included part of the device monitoring session (e.g., have not been removed from the group) that identify how to access the escrowed session data 154, and that the user device 106A of the initiator is no longer sending updates. According to some configurations, the check-in may be a confirmation received from the initiator 102 to continue the session and/or based on data (e.g., location data and/or device data) that indicates that the user device of the initiator is still making progress toward the destination, and/or the initiator is actively using the user device, and the like. In some examples, the message 170 can be re-scheduled for delivery to the receiver at each check-in. For instance, the monitoring service may re-schedule the release of the session data 154 to two hours later (or some other time) each time the check-in determination is successful.

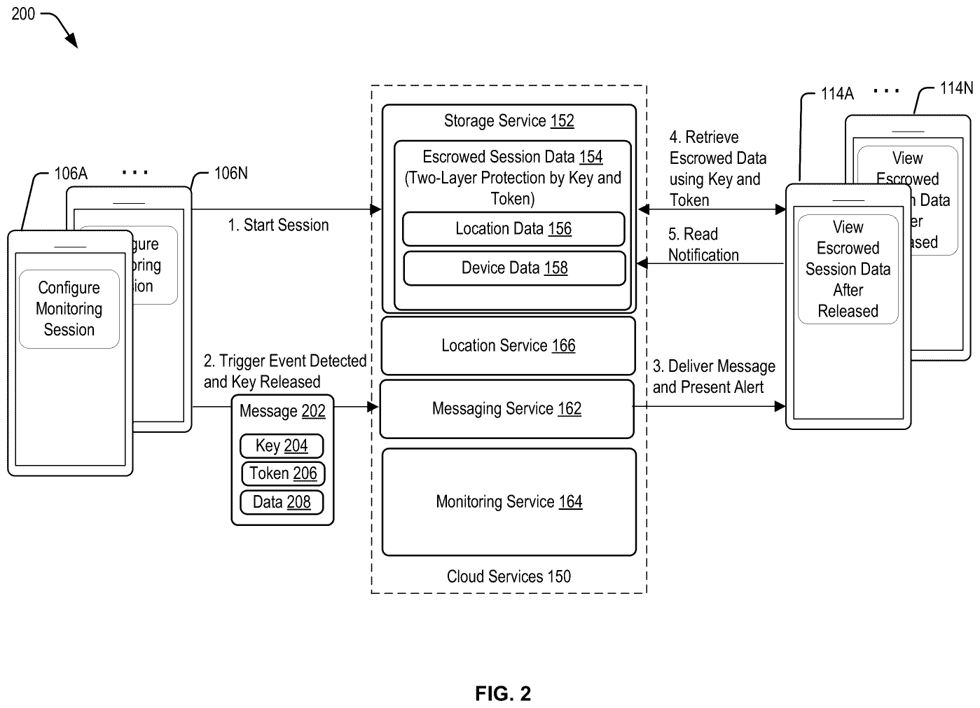

In some examples, the message 170B that is sent to the receiver that authorizes the release of session data can include a token to access the session data within the secure data store, and/or the cryptographic key used to decrypt the session data. See FIG. 2 and related discussion for more information. In some examples, when the user device 106A remains online during the triggering event, the message 170B includes the token to access the session data and the key to decrypt the session data. In other examples, when the user device 106A is offline during the triggering event, the message 170B includes the key but not the token. In this scenario, the storage service 152 may be configured to release the session data after a predetermined time. To further enhance the security of the session data, the messages sent between the initiator and the receiver may be end-to-end encrypted.

FIG. 2 depicts a block diagram of an example environment 200 for implementing the disclosed techniques, according to some embodiments. The environment 200 may include one or more user devices 106A-106N associated with the initiator, and one or more user devices 114A-114N associated with the one or more receivers selected to be part of the device monitoring session, and cloud services 150 that can include services such as a storage service 152, a messaging service 162, and a monitoring service 164.

In the example environment 200, the initiator configures a monitoring session on one of the devices 106A-106N with the receiver(s) associated with the selected receiver devices 114A-114N. After the initiator 102 starts the monitoring session, the monitoring service 164 starts collecting and storing session data 154 associated with at least one of the user devices 106 (e.g., the currently active user device). As discussed above, the session data 154 may include location data 156, device data 158, and possibly other data. The location data 156 may come directly from a user device 106, and/or from some other application/service. For instance, the location data may come from a location service 166 that may provide location-based services for one or more user devices 106, such as device 106A. In some configurations, the location service 166 may monitor the location of one or more of the user devices 106 for one or more authorized purposes (e.g., driving directions, monitoring service, . . . ). The monitoring service 164, and/or some other device/component may collect device data 158.

In the current example, when a triggering event is detected by the monitoring service 164, and the associated user devices 114 of the selected recipients are online, message 202 is sent from the currently active device 106, such as user device 106A to the selected recipient devices 114. The message 202 may include information such as a key 204, a token 206, and data 208. The key 204 may be used by device 114 to decrypt the session data 154 escrowed by the storage service 152. The token 206 may be used by the user device 114 to access the escrowed session data 154 that is stored by the storage service 152. The data 208 may include information indicating that a problem/safety issue has been identified during the monitoring session, and that the receiver may access the session data 154.

In some examples, after a user device 114 accesses the escrowed session data, a read notification is transmitted to the storage service 152 that indicates that the escrowed session data 154 has been accessed. In some examples, the message 202 may be end-to-end encrypted between the user device 106 and the user device(s) 114. This end-to-end encryption provides an additional level of security to protect the escrowed session data 154.

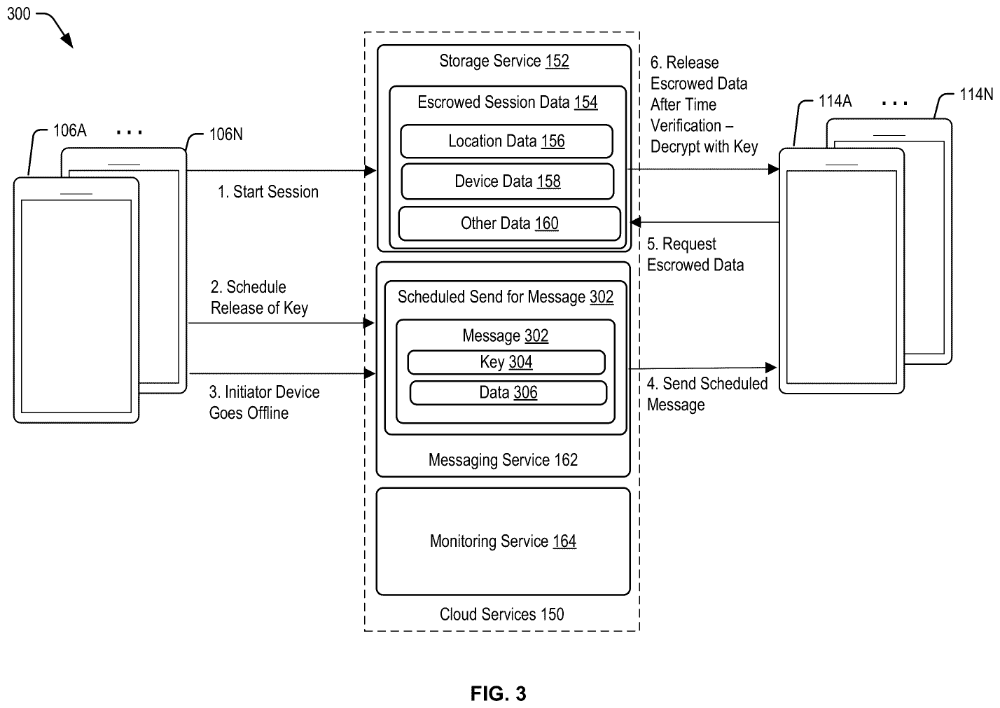

FIG. 3 depicts a block diagram of an example environment 300 for implementing the disclosed techniques, according to some embodiments. The environment 300 may include one or more first user devices 106A-106N associated with the initiator, and one or more user devices 114 associated with the receiver(s), and cloud services 150 that can include services such as a storage service 152, a messaging service 162, and a monitoring service 164. FIG. 3 is similar to FIG. 2 but shows another scenario in which a message 302 is scheduled to be delivered from cloud services 150 in case of the initiator user device 106 that is currently active is unreachable for some period of time (e.g., lost network connectivity, being destroyed, lost, . . . ).

In the example of FIG. 3, a message 302 is scheduled to be sent by the messaging service 162 to the receiver(s) at some future time (e.g., in 2 hours, 1 hour, 4 hours, and the like). According to some embodiments, the storage service 152 performs a time check to determine whether to release the escrowed session data 154 to the user device(s) 114 in response to receiving a request from the user device(s) 114. When a device, such device 114A receives the message 302 (since device 114A is still a part of the device monitoring session) and requests access to the escrowed session data 154, the storage service 152 determines if the current time is past a scheduled time (that indicates when the escrowed session data 154 can be released). When the current time is past the scheduled time, the storage service 152 allows the user device 114 to access the escrowed session data 154. The user device 114 can then use the key 304 to decrypt the data.

In the example illustrated, the message 302 does not include a token. Instead, the time check is used to determine whether to allow the receiver access to the cached data on the server. In other examples, both a time check and a token may be used.

FIG. 4 illustrates UI elements 400 that may be used to start and configure device monitoring sessions. In some examples, different types of user interfaces may be used to configure and receive information relating to a device monitoring session. For instance, in some examples, a user may configure a session using voice command (e.g., the user may say “Hey device, start a location-based device monitoring session,” . . . ). In other examples, a user may use graphical UI elements, or some other type of input technique.

In the example illustrated in FIG. 4, the user may access UI elements, such as the UI elements 410A-410F to configure the device monitoring session. In other examples, the user may configure a device monitoring session by tapping, long pressing, or hard pressing a physical button, and/or some UI element, such as “Establish” illustrated in UI element 410A and UI element 410B.

In some examples, if the initiator is currently messaging with the receiver, content from one or more of the messages may be used by the monitoring service 164 to determine whether to provide a message (so some other UI element) to a user to initiate a device monitoring session. In the example of display 402, a receiver “R” has asked for a message confirming that the initiator “I” arrived home safely. According to some configurations, in response to selecting UI element 410A, display 406 may be displayed that includes UI elements 410C-410E that allow the initiator to configure a new device monitoring session. In other cases, a new device monitoring session can be started directly from an application. In the example illustrated by display 412, the user can start a device monitoring session for a workout using UI element 410G.

In the second example illustrated in display 404, the initiator has messaged the receiver indicating that they are waiting for a worker to finish fixing a dishwasher that should take about 30 minutes to complete. According to some configurations, in response to selecting UI element 410B, display 408 may be displayed that includes UI elements 410F-410G that allow the initiator to configure a new device monitoring session. In other examples, a configure device monitoring session may be displayed in response to other events, such as in response to messaging a particular person, a time of day, a location, and the like.

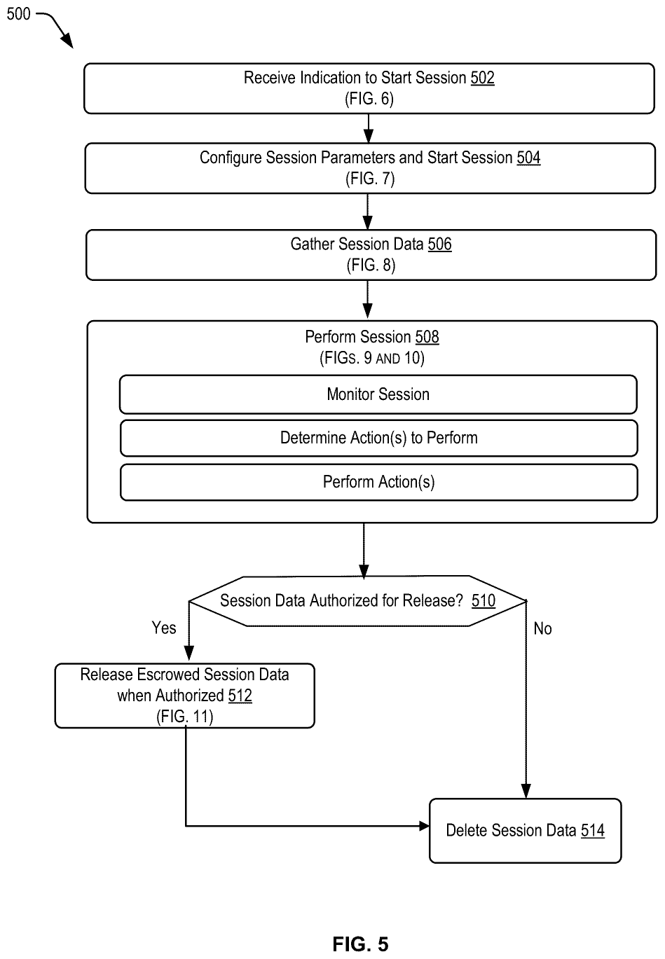

FIG. 5 is an example flow 500 that details a process for implementing the disclosed techniques, according to some embodiments. It should be appreciated that the flow 500 may include a greater number or a lesser number of operations than those depicted in FIG. 5 and that operations in FIG. 5 may be performed in any suitable order. The operations of the flows described herein may be performed by at least one of the user devices 106, user devices 114, one or more computing devices associated with cloud services 150 of FIG. 1, or any computing device/processor configured to provide such functionality (e.g., a wearable computing device), or any suitable combination.

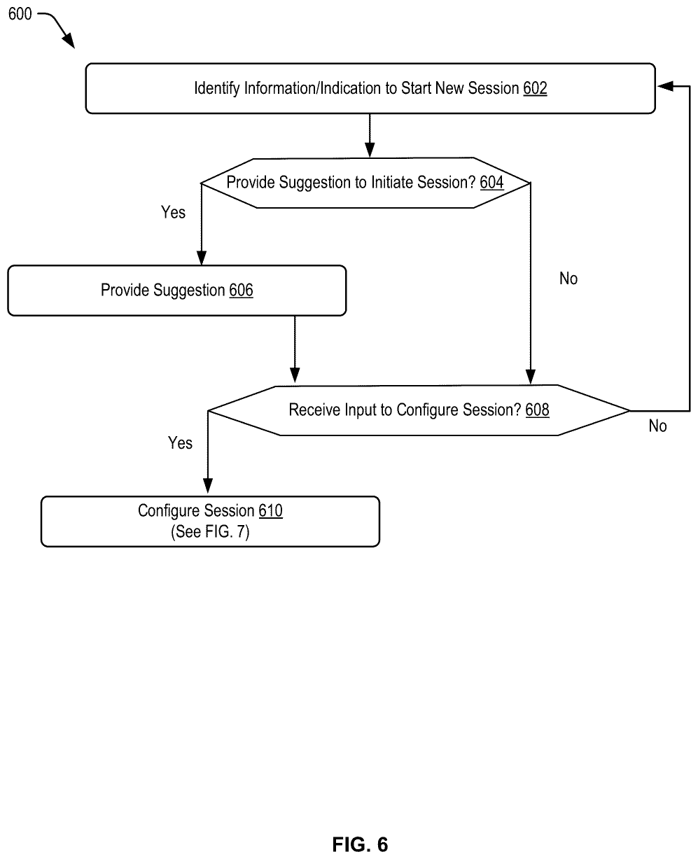

The flow 500 may begin at 502, where an indication to start a device monitoring session is received. In some examples, the initiator 102 may select a UI element to start and configure a device monitoring session. In other examples, a recommendation/suggestion may be provided to a user to configure a device monitoring session. See FIG. 6 and related discussion for more information.

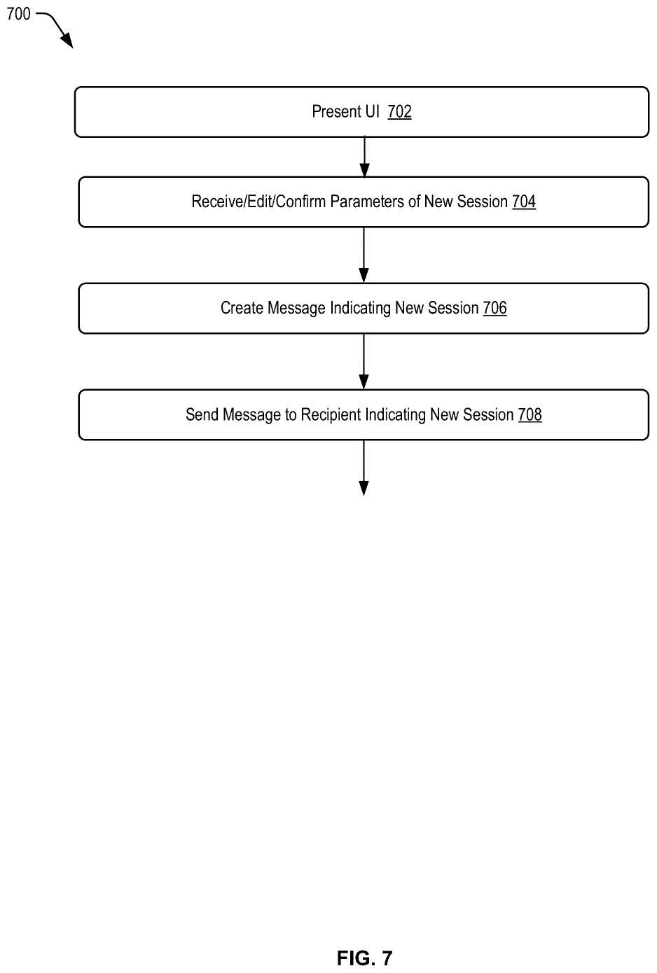

At 504, session parameters are configured, and the device monitoring session is started. In some instances, one of the user devices 106, such as the current user device 106 being used by the initiator, may present a device monitoring UI. For example, a device monitoring UI may be any type of software application that can provide a UI for creating, configuring, and performing actions relating to a device monitoring session. In some instances, there may be various views within the device monitoring UI. See FIG. 7 and related discussion for further information.

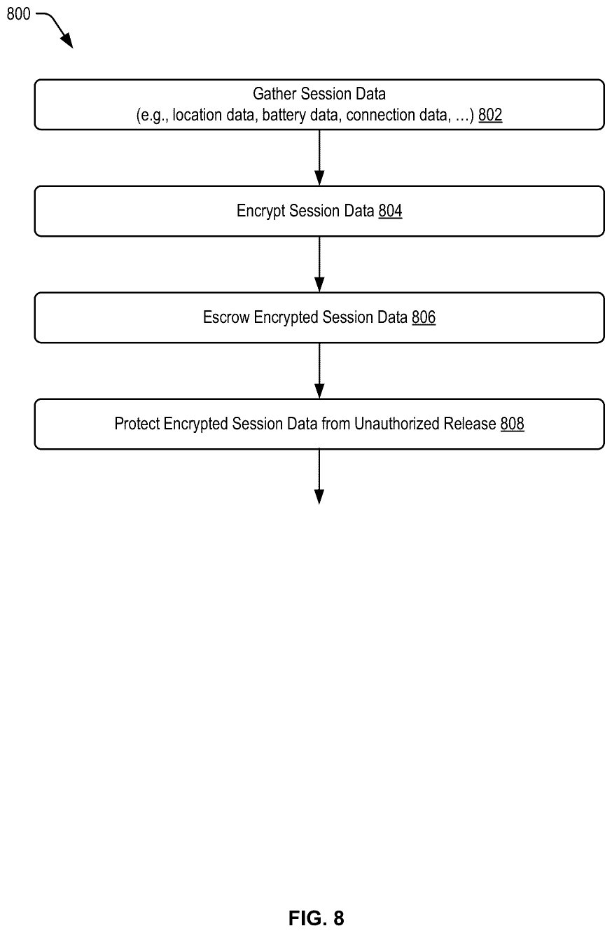

At 506, session data is gathered. In some examples, the session data includes data such as location data and device data (e.g., battery level, usage data, . . . ) associated with at least one of the user devices 106. In some examples, the session data is collected from the currently active device 106 of the initiator. The session data 154 may be collected directly from the determined user devices 106, and/or from one or more other applications/services, such as device monitoring service (safety service) 164, and/or location-based service 166 in cloud services 150. See FIG. 8 and related discussion for further information.

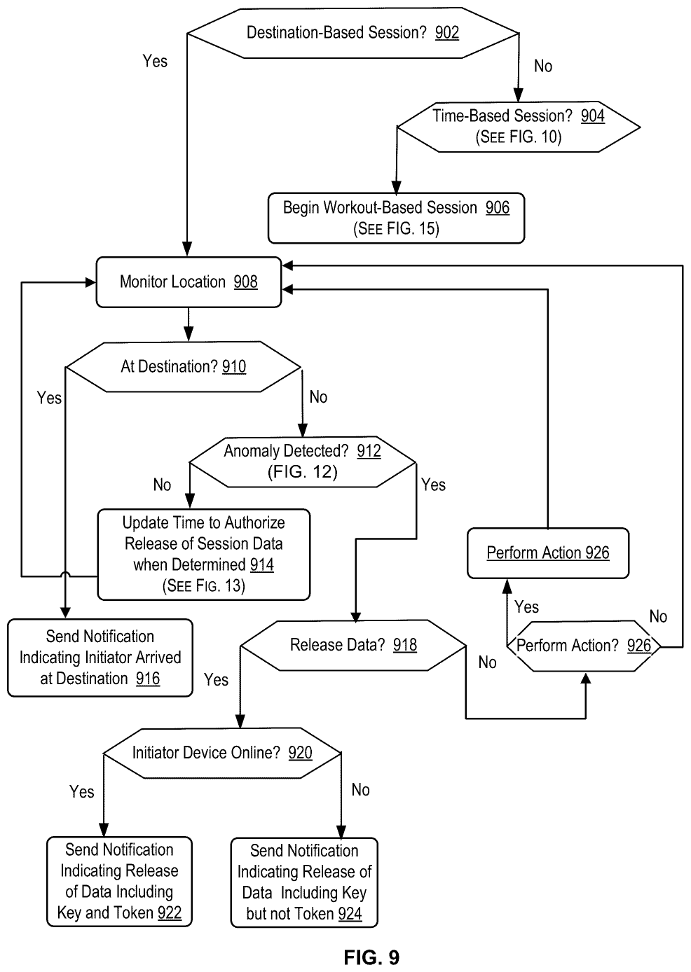

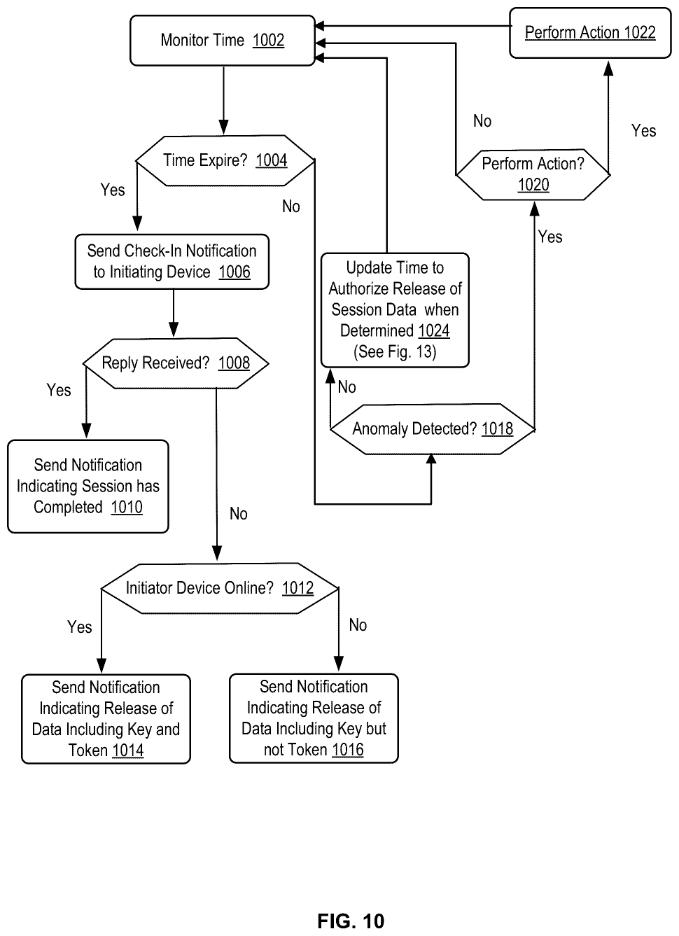

At 508, the session is performed. In some examples, performing the session includes the monitoring service 164 monitoring the session, determining action(s) to perform based on the monitoring, and performing the action(s). According to some embodiments, one or more of the user devices 106, the device monitoring service 164, and the messaging service 162 are configured to perform operations relating to performing the session. See FIGS. 9 and 10 and related discussion for further information.

At operation 510, a determination is made as to whether the session data 154 is authorized for release to the receiver, or the selected receivers when a group of receivers are selected to be part of the device monitoring session. Generally, the session data 154 may be authorized for release upon detection of an anomaly, by the monitoring service 164, during the monitoring session. For instance, the monitoring service 164 may determine that the currently active device 106 of the initiator has failed to check-in within a predetermined period, the currently active device 106 is moving away from a specified destination, the currently active device 106 has failed to make progress toward the specified destination, and the like. In some examples, the session data can be authorized for release by user input, or some other predetermined condition. When the session data 154 is authorized for release, the flow moves to 512. When the session data 154 is not authorized for release, the flow moves to 514.

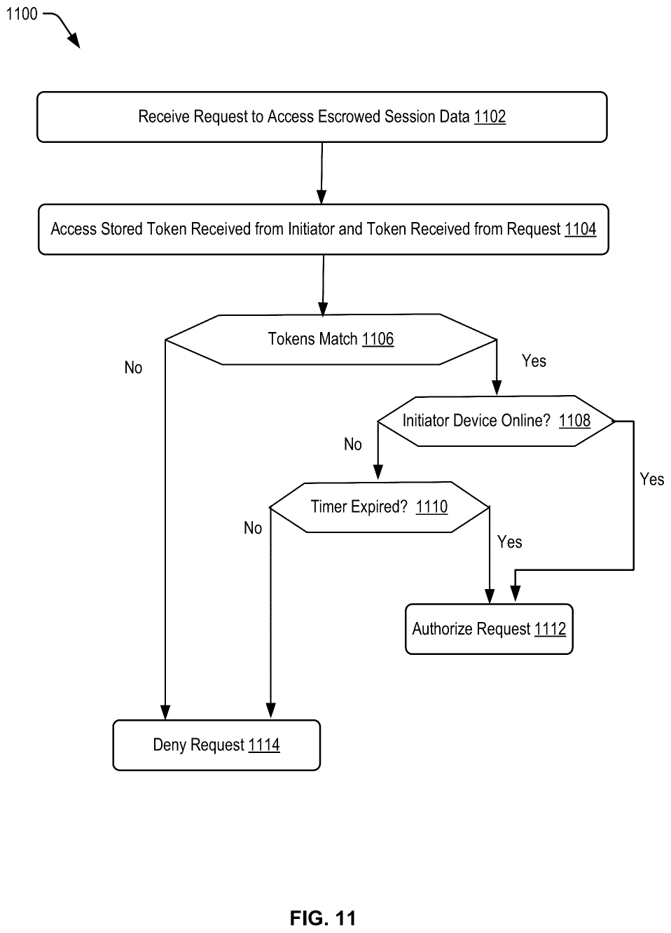

At 512, the escrowed session data 154 is authorized to be released to the receiver(s). As discussed above, each of the receiver(s) may be sent a message that includes information such as a key and/or a token that may be used to view and access the escrowed session data. See FIG. 11 and related discussion for further information.

At 514, the escrowed session data can be deleted. In some instances, the session data is deleted at some point after a session has ended (e.g., an hour, two hours, a day, . . . ).

FIG. 6 is an example flow 600 that details a process for implementing the disclosed techniques, according to some embodiments. It should be appreciated that the flow 600 may include a greater number or a lesser number of operations than those depicted in FIG. 6 and that the depicted operations may be performed in any suitable order. The operations of flow 600 may be performed any computing device/processor configured to provide such functionality.

The flow may begin at 602, where information/indication to start a new session is identified. In some instances, the information may be input received from interaction with one or more UI elements. In other instances, the monitoring service 164 may use data from messages (or other sources) to provide a suggestion to the initiator 102 to start a new session.

At 604, a determination is made as to whether to provide suggestions to initiate the session. In some examples, that determination can be made based on information contained within messages, a time of day, a location, previous sessions, a workout is started, and the like. When a suggestion is to be provided, the flow moves to 606. When a suggestion is not to be provided, the flow moves to 608.

At 606, the suggestions are provided. In some examples, the suggestions are provided within a user interface element that is presented on the user device 106A. For instance, a UI element may be displayed on user device 106A that when selected allows the initiator to change/specify parameters relating to starting a new session.

At 608, a determination is made as to receive input to configure the device monitoring session. In some examples, a device monitoring UI is presented to the initiator of the monitoring session to receive configuration parameters. In other examples, the monitoring service 164 may automatically specify the parameters of the monitoring session. When input is to be received, the flow moves to 610. When input is not to be provided, the flow returns to 602.

At 610, the session is configured. In some instances, the initiator specifies/changes parameters using a UI. See FIG. 7 and related discussion for more information.

FIG. 7 is an example flow 700 that details a process for implementing the disclosed techniques, according to some embodiments. It should be appreciated that the flow 700 may include a greater number or a lesser number of operations than those depicted in FIG. 7 and that the depicted operations may be performed in any suitable order. The operations of flow 700 may be performed any computing device configured to provide such functionality.

The flow 700 may begin at 702, where a user interface is presented on a computing device, such as user device 106A. In some examples, the UI is presented on a mobile computing device, such as a phone, tablet, a wearable device, or some other device. According to some examples, the UI elements may change depending on the type of computing device. For instance, fewer/smaller UI elements may be presented on smaller screens, as compared to larger screens. In some examples, parameters may be received via non-graphical user interface elements, such as voice, and/or a Command Line Interface (CLI).

At 704, parameters of a new session are received/edited/confirmed. In some instances, the monitoring service 164 and/or the application module 108, causes the display of UI elements to configure the session. The initiator may use these UI elements to change/configure the parameters for the session.

At 706, a message indicating a new session is created. In some examples, a messaging service 162 is used to create the message. According to some configurations, the message includes information that indicates that the initiator 102 is starting a new time-based device monitoring session, a new destination-based device monitoring session, or a workout device monitoring session.

At 708, the message indicating the new session is sent to the receiver(s). In some examples, the messaging service 162 transmits the message to the receiver(s). According to some examples, the message is end-to-end encrypted between the initiator 102 and the receiver 104 to increase privacy.

FIG. 8 is an example flow 800 that details a process for implementing the disclosed techniques, according to some embodiments. It should be appreciated that the flow 800 may include a greater number or a lesser number of operations than those depicted in FIG. 8 and that the depicted operations may be performed in any suitable order. The operations of flow 800 may be performed any computing device configured to provide such functionality.

Flow 800 may begin at 802, where session data is gathered. In some examples, the session data 154 gathered by the monitoring service 164 includes location data associated with one or more of the user devices 106, battery data, connection data (e.g., WiFI, cellular, . . . ), and the like.

At 804, the session data is encrypted. In some examples, the monitoring service 164 encrypts the session data 154 using the cryptographic key associated with the initiator.

At 806, the encrypted session data is escrowed within a data store. In some examples, the encrypted session data 154 is stored by the monitoring service 164 within a secure storage service 152 of cloud services 150. In this way, the session data 154 is protected from unauthorized access/release by two different techniques. According to some instances, the storage service 152 uses a token to protect access to the session data in addition to the session data being encrypted.

At 808, the encrypted session data 154 is protected from unauthorized release. As discussed above, in some examples, the session data 154 is unable to be accessed unless the receiver provides the token and the key that are included within the authorization to release message. In other examples, the secure storage service 152 waits to release the session data 154 until the current time is past a specified release time in request to a response by the authorized receiver 104.

FIG. 9 is an example flow 900 that details a process for implementing the disclosed techniques, according to some embodiments. It should be appreciated that the flow 900 may include a greater number or a lesser number of operations than those depicted in FIG. 9 and that the depicted operations may be performed in any suitable order. The operations of flow 900 may be performed any computing device configured to provide such functionality.

The flow 900 may begin at 902, where determination is made as to whether the device monitoring session is a destination-based session, a time-based session, or a workout-based session. As discussed above, the initiator may decide between a monitoring session that monitors the user device 106A as it travels to a specified destination, a time-based session that monitors the user device 106A for a specified period, or a workout-based session. When the session is a destination-based session, the flow moves to 906. When the session is a time-based session, the flow moves to 904. When the session is a workout-based session, the flow moves to 906.

At 904, a time-based session is started. As discussed above, a time-based session monitors the user device 106A for a specified period. See FIG. 10 and related discussion for further information.

At 906, the location of the user device 106A is monitored. In some examples, the location service 166 monitors the location the user device 106A and obtains location information (e.g., GPS coordinates) of the user device 106A that may be used by the monitoring service 164. In other examples, the monitoring service 164 can directly collects location data from the user device 106A.

At 906, a workout associated with the user is monitored by one or more of the user devices 106. For example, in some examples, the workout is monitored by the user device 106 that started the workout. In some cases, data from other devices associated with the user may also be monitored during a workout session when authorized (e.g., a heart rate monitor, exercise equipment, and/or other data from one or more other devices). See FIG. 15 and related discussion for further information.

At 908, the location service 166 monitors the location one or more of the user devices 106 (e.g., the currently active device) and obtains location information (e.g., GPS coordinates) of the user device 106 that may be used by the monitoring service 164. In other examples, the monitoring service 164 can directly collects location data from the user device 106.

At 910, a determination is made as to whether a user device 106 has reached the specified destination. In some examples, the device 106 a is determined to be at the specified destination by the monitoring service 164 when the user device 106 has been at the specified destination for a specified period. (e.g., 5 minutes, 10 minutes, . . . ). In some examples, the monitoring service 164 monitors the location of the currently active device. In other examples, the monitoring service 164 may monitor location data from more than one of the user devices 106. When the session is at the destination, the flow moves to 914. When the session is not at the destination, the flow moves to 910.

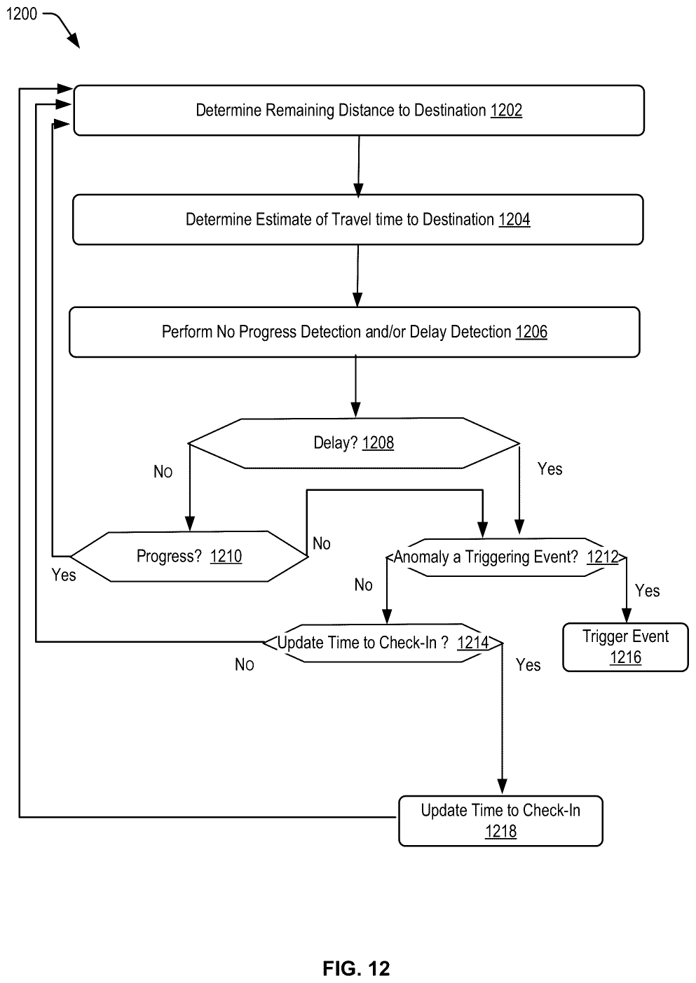

At 912, a determination is made as to whether an anomaly is detected. As discussed above, the monitoring service 164 may determine based, at least in part, on the gathered session data that the initiator may be experiencing a safety issue. See FIG. 12 and related discussion for further information.

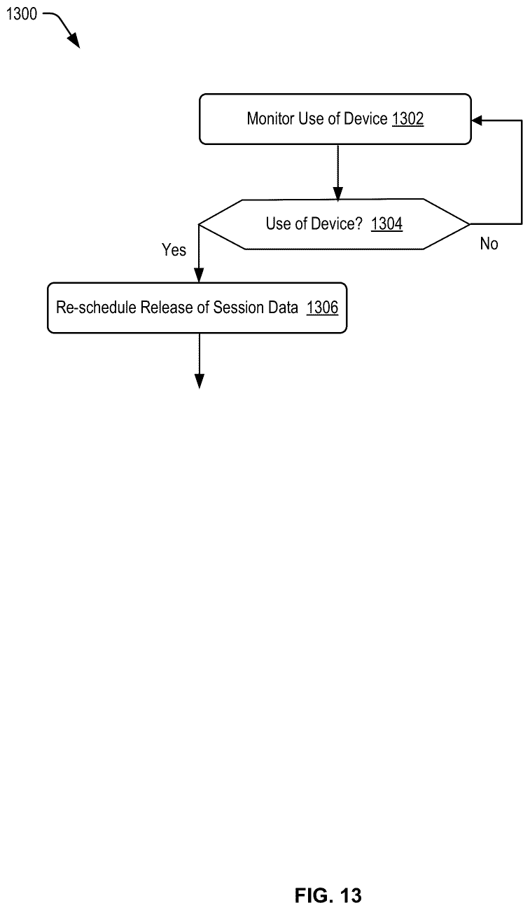

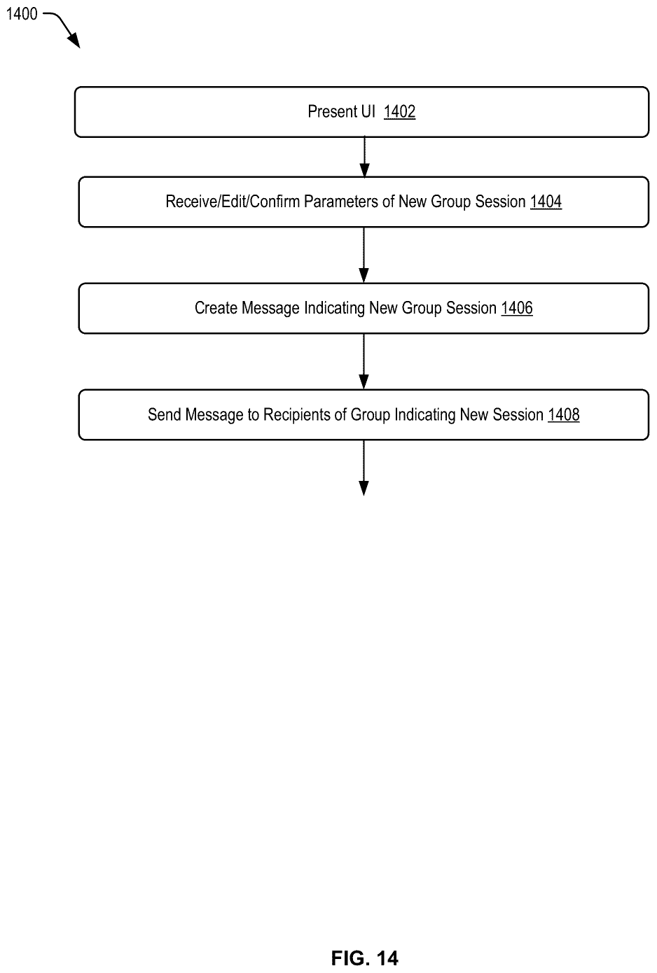

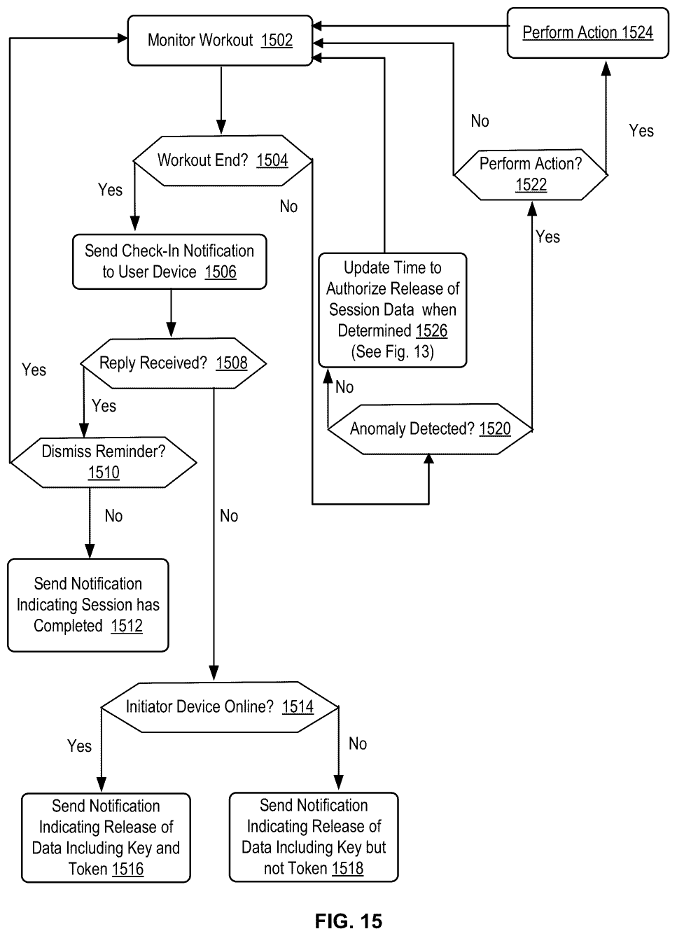

At 914, the time to authorize the release of the session data is updated when determined. In some instances, the monitoring service 164 updates a time to authorize the release of the session data to the receiver(s) in response to the user device 106 making progress to the destination and/or the initiator indicating to continue the session. See FIG. 13 and related discussion from more information.

At 916, a notification indicating the initiator has arrived at the destination is sent to the receiver(s). As discussed above, the monitoring service 164 may send a message (e.g., via the messaging service 162) to each of the receivers that includes information that the initiator is safe, and that the session has ended.

At 918, determination is made as to whether to release the session data. As discussed above, the monitoring service 164 may determine that the anomaly indicates a safety concern for the initiator and authorize the release of the session data 154. For instance, the anomaly may be a detected crash, an emergency call was made by the initiator, the initiator is not responding, the initiator is moving away from the destination, the initiator has deviated from a known pattern, and the like. When the session data is to be released, the flow moves to 920. When the session data is not to be released, the flow moves to 926.

At 920, a determination is made as to whether a user device 106 is online. In some instances, the monitoring service 164 uses connection data obtained about the user device 106 that indicates whether the user device 106 is online and connected to the monitoring service 164. When a user device 106 is online, the flow moves to 920. When a user device 106 is not online, the flow moves to 922.

At 922, the notification indicating the release of the session data 154 including the key and token is sent to the user devices 114 associated with the receivers. As discussed above, the monitoring service 164 may include both the token to access the session data 154 within the secure storage service 152 and the key to decrypt the session data 154 when a user device 106 is still online when the release of the session data 154 is authorized.

At 924, a notification indicating release of the session data 154 including the key but not the token is sent to the user devices 114 associated with the receivers. As discussed above, the monitoring service 164 may include the key to decrypt the session data 154, but not the token, when a user device 106 is not online. In this scenario, as discussed above, the storage service 152 uses a time-based check to determine whether to release the session data 154 to the receiver.

At 926, a determination is made as to whether to perform an action. When there is an action to perform, the flow moves to 928. When there is not an action to perform, the flow moves to 908.

At 928, the action is performed. In some instances, the action may be a check-in action that sends a check-in message to one or more of the user devices 106 that requests an indication to continue or end the session, and/or a release session data action that includes sending a release session data message to the user devices 114 indicating that the receivers are authorized access the encrypted session data 154 from the secure storage service 152. After performing the action, the flow may return to operation 906.

FIG. 10 is an example flow 1000 that details a process for implementing the disclosed techniques, according to some embodiments. It should be appreciated that the flow 1000 may include a greater number or a lesser number of operations than those depicted in FIG. 10 and that the depicted operations may be performed in any suitable order. The operations of flow 1000 may be performed any computing device configured to provide such functionality.

The flow of 1000 may begin at 1002, where the time is monitored. As discussed above, the initiator may configure a time-based monitoring session that monitors one or more of the user devices 106 for a specified period (e.g., 30 minutes, an hour, two hours, . . . ). In some examples, a device 106 that is the currently active device is monitored. More details are provided below.

At 1004, a determination is made as to whether the time has expired. In some instances, the monitoring service 164 maintains one or more timers to keep track of the time. When the time has expired, the flow moves to 1006. When the time has not expired, the flow moves to 1018.

At 1006, a check-in notification is sent to one or more of the user devices 106. As discussed above, the monitoring service 164 may send a check-in notification to the user device 106 that is the currently active device to request an indication from the initiator to end the session. In other examples, the monitoring service 164 may send a check-in notification to each of the user devices 106. For example, at the end of time-based session, the monitoring service 164 may use the message to confirm that the initiator is safe.

At 1008, a determination estimate made as to whether a reply has been received from one of the user devices 106. For example, the reply may be received from the currently active device or a user device 106 that is not the currently active device. In some instances, the monitoring service 165 may wait a predetermined period before determining whether a reply has been received. For example, the monitoring service 164 may wait five minutes to provide sufficient time for the initiator to respond.

At 1010, a notification is sent indicating the time-based session has completed. As discussed above, the monitoring service 164 may instruct the messaging service 162 to deliver a message to the receivers 114 indicating that the session ended successfully.

At 1012, a determination is made as to whether one of the user devices 106 is online. In some instances, the monitoring service 164 uses connection data obtained about the currently active device that indicates whether the user device 106 is online and connected to the monitoring service 164. When the user device 106 is online, the flow moves to 1014. When the user device 106 is not online, the flow moves to 1016.

At 1014, the notification indicating the release of the session data 154 including the key and token is sent to the user devices 114 associated with the receivers. As discussed above, the monitoring service 164 may include both the token to access the session data 154 within the secure storage service 152 and the key to decrypt the session data 154 when the user device 106 is still online when the release of the session data 154 is authorized.

At 1016, a notification indicating release of the session data 154 including the key but not the token is sent to the user devices 114 associated with the receivers. As discussed above, the monitoring service 164 may include the key to decrypt the session data 154, but not the token, when the user device 106 is not online. In this scenario, as discussed above, the storage service 152 uses a time-based check to determine whether to release the session data 154 to the receiver.

At 1018, a determination is made as to whether an anomaly is detected. As discussed above, the monitoring service 164 may determine based, at least in part, on the gathered session data that the initiator may be experiencing a safety issue. See FIG. 12 and related discussion for further information. When an anomaly is detected, the flow moves to 1020. When an anomaly is not detected the flow moves to 1024.

At 1020, a determination is made as to whether to perform an action. When there is an action to perform, the flow moves to 1022. When there is not an action to perform, the flow moves to 1002.

At 1022, the action is performed. In some instances, the action may be a check-in action that sends a check-in message to one or more of the user devices 106 that requests an indication to continue or end the session, and/or a release session data action that includes sending a release session data message to the user devices 114 indicating that the receivers is authorized access the encrypted session data 154 from the secure storage service 152. After performing the action, the flow may move to 1002.

At 1024, the time to authorize the release of the session is updated when determined. As discussed herein, the time may be updated in response to detecting use of the user device 106A. See FIG. 13 and related discussion.

FIG. 11 is an example flow 1100 that details a process for implementing the disclosed techniques, according to some embodiments. It should be appreciated that the flow 1100 may include a greater number or a lesser number of operations than those depicted in FIG. 11 and that the depicted operations may be performed in any suitable order. The operations of flow 1100 may be performed any computing device configured to provide such functionality.

The flow 1100, may begin at 1102, where a request to access the escrow session data is received. In some instances, the secure data storage service 152 receives the request transmitted by the user devices 114 associated with the receivers 104.

At 1104, the stored token received from the initiator 102 user device 106 and the token accessed from the request is compared. As discussed above, the storage service 152 may protect the session data 154 using a token. In this scenario, the storage service 152 compares the tokens to determine whether they match.

At 1106, a determination is made as to whether the tokens match. In some instances, the storage service 152 performs the comparison. When the tokens match, the flow moves to 1108. When the tokens do not match, the flow moves to 1114.

At 1108, a determination is made as to whether a user device 106, such as the currently active device, is online. In some instances, the monitoring service 164 uses connection data obtained about one or more of the user devices 106 that indicates whether a user device 106 is online and connected to the monitoring service 164. When a user device 106 is online, the flow moves to 1112. When a user device 106 is not online, the flow moves to 1110.

At 1110, a determination is made as to whether the timer has expired. In some instances, the monitoring service 164 maintains a timer to determine whether an amount of time has passed since determining receiving a check-in from a user device 106. When the timer has expired, the flow moves to 1112. When the timer has not expired, the flow moves to 1114.

At 1112, the request to access the session data 154 is authorized. In some instances, the monitoring service 164 authorizes the release of the session data 154 to the user device 114, or some other device associated with the receiver.

FIG. 12 is an example flow 1200 that details a process for implementing the disclosed techniques, according to some embodiments. It should be appreciated that the flow 1200 may include a greater number or a lesser number of operations than those depicted in FIG. 12 and that the depicted operations may be performed in any suitable order. The operations of flow 1200 may be performed any computing device configured to provide such functionality.

The flow of 1200 may begin at 1202, where the distance remaining to the destination is determined. In some instances, the monitoring service 164 may determine, or cause to be determined, a remaining distance to the destination. The remaining distance may be a driving distance, a straight-line distance, or some other measurement that indicates a distance between the current location and the specified destination.

At 1204, the estimated travel time to the destination is determined. In some examples, the estimated travel time is based on mapping information using a mode of transportation associated with the user device 106. For instance, a location-based service 166 may be configured to provide an estimated travel time. In other examples, the monitoring service 164 may estimate a travel time.

At 1206, a no progress detection and/or a delay detection is performed. In some examples, the monitoring service 164 performs a no progress detection that determines whether a device 106 is making progress (e.g., getting closer to the destination). The monitoring service 164 may also determine whether a user device 106 has been delayed (e.g., traffic, or some other incident that may cause a delay).

At 1208, a determination is made if there is a delay to the destination. According to some examples, the monitoring service 164 uses the location data and/or the device data to assist in making this determination. When there is a delay, the flow moves to 1212. When there is not a delay, the flow moves to 1212.

At 1210, a determination is made by the monitoring service 164 if progress is being made to the destination. When there is not progress, the flow goes moves to 1212. When there is progress, the flow returns to 1202.

At 1212, determination is made as to whether an anomaly that is a triggering event has occurred. As discussed above, the monitoring service 164 may determine based, at least in part, on the gathered session data that the initiator may be experiencing a safety issue. For example, when the currently active device of the user devices 106 has been delayed for a specified period (e.g., 20 minutes, 60 minutes, . . . ) an anomaly may be detected. When an anomaly that is a triggering event has not occurred, the flow moves to 1214. When there is an anomaly that is a triggering event, the flow moves to 1216.

At 1214, a determination is made as to whether to update the check in time. As discussed above, the check-in time may be updated by the monitoring service 164 such that the session data 154 is not released until an occurrence of a triggering event or an expiration of time. When the check-in time does not need to be updated, the flow returns to 1202. When check-in time does need to be updated, the flow moves to 1218.

At 1216, a trigger event is generated. As discussed above, the monitoring service 164 generates a trigger event that indicates to authorize the release of the session data 154 to the receivers.

At 1218, the time to check in is updated. In some examples, a predetermined amount of time is added to the current check-in time. In this way, the initiating user has more time to complete the session.

FIG. 13 is an example flow 1300 that details a process for implementing the disclosed techniques, according to some embodiments. It should be appreciated that the flow 1300 may include a greater number or a lesser number of operations than those depicted in FIG. 13 and that the depicted operations may be performed in any suitable order. The operations of flow 1300 may be performed any computing device configured to provide such functionality.

The flow 1300, may begin at 1302 or use of one or more user devices 106 is monitored. In some examples, monitoring the user device(s) 106 may include determining whether a user is interacting with an application, whether the user has unlocked their device within a period, whether the user has engaged with the device in some other way, and the like.

At 1304, determination is made as to whether a user device 106 is being used. In some examples, the monitoring service 164 monitors device data (e.g., device unlock, use of applications/services, . . . ) of a user device 106 to determine use. When there not has not been any use of the device, the flow returns to 1302. When there is use of the device, the flow moves to 1306.

At 1306, the release of the session data is re-scheduled to a later point in time. As discussed herein, the monitoring service 164 may not authorize release of the session data 154 during a time the user device 106 is being used.

FIG. 14 is an example flow 1400 that details a process for implementing the disclosed techniques, according to some embodiments. It should be appreciated that the flow 1400 may include a greater number or a lesser number of operations than those depicted in FIG. 14 and that the depicted operations may be performed in any suitable order. The operations of flow 1400 may be performed any computing device configured to provide such functionality.

The flow 1400 may begin at 1402, where a user interface is presented on a computing device, such as the currently active device of the user devices 106. In some examples, the UI is presented on a mobile computing device, such as a phone, tablet, a wearable device, or some other device. According to some examples, the UI elements may change depending on the type of computing device. For instance, fewer/smaller UI elements may be presented on smaller screens, as compared to larger screens. In some examples, parameters may be received via non-graphical user interface elements, such as voice, and/or a Command Line Interface (CLI). In other examples, a user may cause instruction(s) that have been preprogrammed (e.g., shortcuts) to be performed.

At 1404, parameters of a new group session are received/edited/confirmed. In some instances, the monitoring service 164 and/or the application module 108, causes the display of UI elements to configure the session. The initiator may use these UI elements to change/configure the parameters for the session. For example, the initiator may select/identify members of the group that are to be included in the group session.

At 1406, a message indicating a new group session is created. In some examples, a messaging service 162 is used to create the message. In some examples, different messages may be created for each of the members of the group. According to some configurations, the message includes information that indicates that the initiator 102 is starting a new time-based device monitoring session, a new activity-based device monitoring session, or a new destination-based device monitoring session.

At 1408, the message indicating the new group session is sent to the members of the group (e.g., the recipients). In some examples, the messaging service 162 transmits the messages to the receivers. According to some examples, the message is end-to-end encrypted between the initiator 102 and the receivers 104 to increase privacy.

FIG. 15 is an example flow 1500 that details a process for implementing the disclosed techniques, according to some embodiments. It should be appreciated that the flow 1500 may include a greater number or a lesser number of operations than those depicted in FIG. 15 and that the depicted operations may be performed in any suitable order. The operations of flow 1500 may be performed any computing device configured to provide such functionality.

The flow 1500 may begin at 1502, where the monitoring service 164 monitors the workout. The data monitored by the monitoring service 164 may change based on a type of workout. For example, the monitoring service may monitor location information (e.g., GPS coordinates) of a user device 106 when the workout is an outside workout, while not monitoring location data when the workout is an inside workout. Some other types of data that may be monitored when authorized includes but is not limited to heart rate data, fall data, workout data obtained from one or more devices, such as the currently active device, sensor data obtained from one or more sensors, and the like. In some examples, the monitoring service 164 can collects data from one or more of the user devices 106, as well as from other computing devices.

At 1504, a determination is made as to whether the workout has ended. In some examples, the workout is determined to have ended when the user has selected an option to end the workout. In other examples, the workout may end when a specific time goal, or other goal has been reached (e.g., distance, time at a specific pace/heartrate, . . . ), and the like. When the workout has ended, the flow moves to 1506. When the workout has not ended, the flow moves to 1518.

At 1506, a check-in notification may be sent to one or more of the user devices 106. As discussed above, the monitoring service 164 may send a check-in notification to the user device 106 that is the currently active device to request an indication from the initiator to end the session. In other examples, the monitoring service 164 may send a check-in notification to each of the user devices 106. For example, at the end of a workout session, the monitoring service 164 may use the message to confirm that the initiator is safe.

At 1508, a determination estimate made as to whether a reply has been received from one of the user devices 106. For example, the reply may be received from the currently active device or a user device 106 that is not the currently active device. In some instances, the monitoring service 165 may wait a predetermined period before determining whether a reply has been received. For example, the monitoring service 164 may wait five minutes to provide sufficient time for the initiator to respond.

At 1510, a determination estimate made as to whether a reply is to dismiss a reminder. For example, the reply may be received in response to an end workout reminder. When the reply is to dismiss a reminder, the flow returns to 1502 to continue monitoring the workout. When the reply is not a dismiss reminder, the flow moves to 1512.

At 1512, a notification is sent indicating the workout-based session has completed. As discussed above, the monitoring service 164 may instruct the messaging service 162 to deliver a message to the receivers 114 indicating that the session ended successfully.

At 1514, a determination is made as to whether one of the user devices 106 is online. In some instances, the monitoring service 164 uses connection data obtained about the currently active device that indicates whether the user device 106 is online and connected to the monitoring service 164. When the user device 106 is online, the flow moves to 1516. When the user device 106 is not online, the flow moves to 1518.

At 1516, the notification indicating the release of the session data 154 including the key and token is sent to the user devices 114 associated with the receivers. As discussed above, the monitoring service 164 may include both the token to access the session data 154 within the secure storage service 152 and the key to decrypt the session data 154 when the user device 106 is still online when the release of the session data 154 is authorized.

At 1518, a notification indicating release of the session data 154 including the key but not the token is sent to the user devices 114 associated with the receivers. As discussed above, the monitoring service 164 may include the key to decrypt the session data 154, but not the token, when the user device 106 is not online. In this scenario, as discussed above, the storage service 152 uses a time-based check to determine whether to release the session data 154 to the receiver.

At 1520, a determination is made as to whether an anomaly is detected. As discussed above, the monitoring service 164 may determine based, at least in part, on the gathered session data that the initiator may be experiencing a safety issue. See FIG. 12 and related discussion for further information.

At 1522, a determination is made as to whether to perform an action. When there is an action to perform, the flow moves to 1522. When there is not an action to perform, the flow moves to 1502.

At 1524, the action is performed. In some instances, the action may be a check-in action that sends a check-in message to one or more of the user devices 106 that requests an indication to continue or end the session, and/or a release session data action that includes sending a release session data message to the user devices 114 indicating that the receivers are authorized access the encrypted session data 154 from the secure storage service 152. After performing the action, the flow may return to operation 1502.

At 1526, the time to authorize the release of the session data is updated when determined. In some instances, the monitoring service 164 updates a time to authorize the release of the session data to the receiver(s) in response to the user device 106 continuing the workout. See FIG. 13 and related discussion from more information.

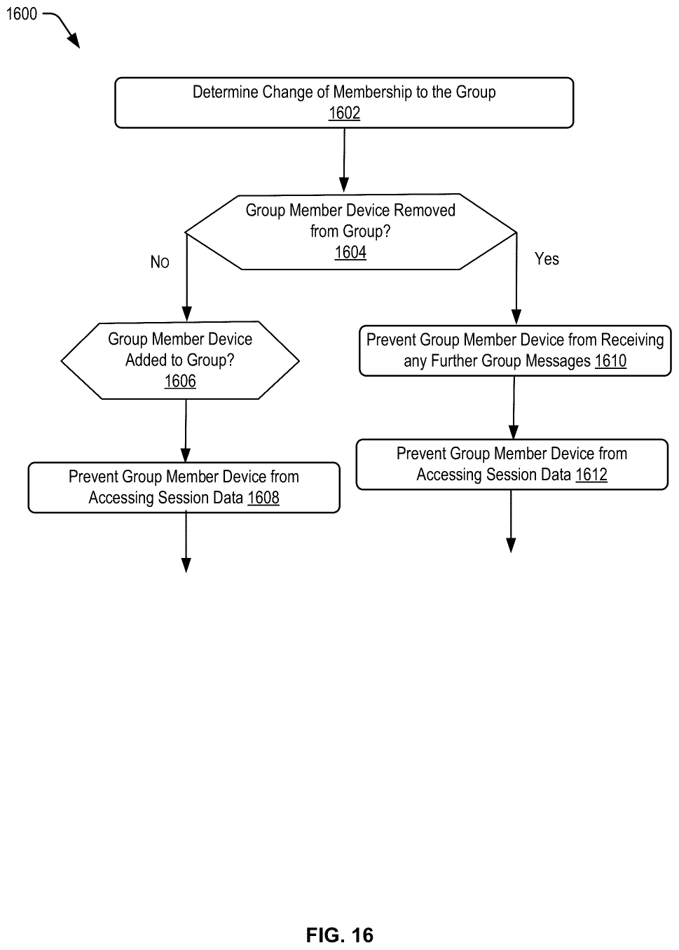

FIG. 16 is an example flow 1600 that details a process for implementing the disclosed techniques, according to some embodiments. It should be appreciated that the flow 1600 may include a greater number or a lesser number of operations than those depicted in FIG. 16 and that the depicted operations may be performed in any suitable order. The operations of flow 1600 may be performed any computing device configured to provide such functionality.

The flow 1600 may begin at 1602, where a change of member in the group is determined. As discussed above, the group of users and associated devices may change during a monitoring session. In some examples, any one of the users, including the initiating user and the current receiving users 104 of the group may initiate a change to the membership of the group. In other examples, the users authorized to change the membership of the group may be limited. For example, one or more of the users of the group and/or the initiator may be authorized to change the membership of the group.

At 1604, a determination is made that a group member device was removed from the group. In some configurations, a group member device may be removed from the group by removing the user from the group associated with the device monitoring session in the messaging application. In other examples, a group member device may be removed by selecting a user interface element. When there is not a group member device removed from the group, the flow moves to 1606. When there is a group member device removed from the group, the flow moves to 1608.

At 1606, a group member device is added to the group. In some examples, a group member device is added to the group associated with the device monitoring session in the messaging application. In other examples, a group member device may be removed by selecting a user interface element presented in a different application.

At 1608, the removed group member device is prevented from receiving any further group messages. According to some examples, removing the group member device from the group in the messaging application prevents the removed user from receiving any further messages from being delivered to that user.

At 1610, the removed group member device is prevented from being able to access the session data. In some configurations, a list indicating the currently active users is updated by the monitoring service 162 and/or the messaging service 162 such that the message and/or token indicating that a device is authorized to access session data is not sent to the removed device.

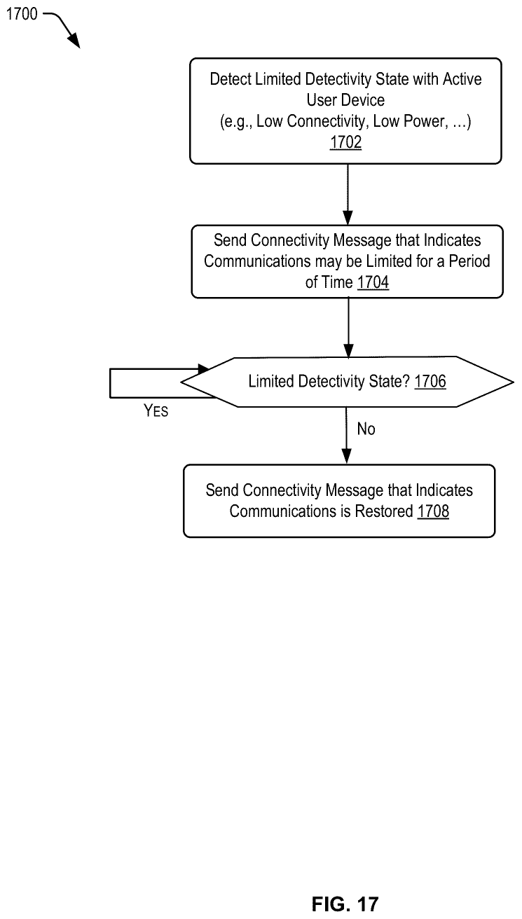

FIG. 17 is an example flow 1700 that details a process for implementing the disclosed techniques, according to some embodiments. It should be appreciated that the flow 1700 may include a greater number or a lesser number of operations than those depicted in FIG. 17 and that the depicted operations may be performed in any suitable order. The operations of flow 1700 may be performed any computing device configured to provide such functionality.

The flow 1700 may begin at 1702, where a limited detectivity state of the currently active device is detected. In some cases, the currently active device of the user devices 106 may experience one or more conditions that affect the ability to communicate with one or more other devices. According to some configurations, the limited detectivity state may include but is not limited to a low battery state (e.g., below 20%, 10%, 5%, . . . ), poor cellular connectivity (e.g., for a period of time, below a specified threshold, . . . ), poor WiFi connectivity (e.g., for a period of time, below a specified threshold, . . . ), and the like.

At 1704, a connectivity message may be sent to the receiver(s) indicating that communications about the monitoring session may be limited for a period of time. For example, the messaging service 162 may send a message to each of the receiver(s) indicating that the initiator's device 106 is not able to communicate reliably, and to not expect communications till a later time.

At 1706, a determination is made as to whether a limited detectivity state is still detected. In some configurations, the monitoring service 164 may periodically test the connection with one or more of the user devices 106. When there still is limited detectivity, the flow returns to 1706. When there not limited detectivity, the flow moves to 1708.

At 1708, a connectivity message may be sent to the receiver(s) indicating that communications about the monitoring session have been restored. For example, the messaging service 162 may send a message to each of the receiver(s) indicating that the initiator's device 106 connection has been restored.

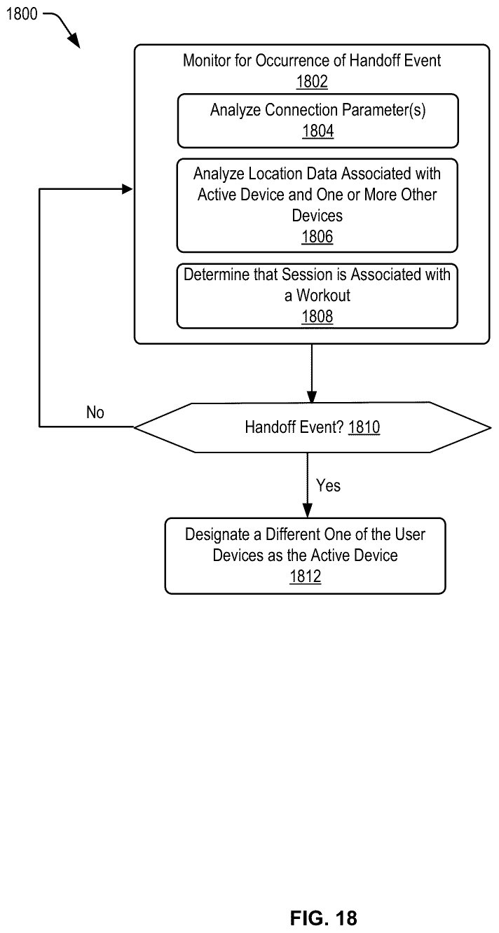

FIG. 18 is an example flow 1800 that details a process for implementing the disclosed techniques, according to some embodiments. It should be appreciated that the flow 1800 may include a greater number or a lesser number of operations than those depicted in FIG. 18 and that the depicted operations may be performed in any suitable order. The operations of flow 1800 may be performed any computing device configured to provide such functionality.

The flow 1800 may begin at 1802, where the occurrence of a handoff event is monitored. As discussed above, in some cases the user device 106 that initiated the device monitoring session may not be the user device 106 that is being monitored and/or providing session data for the monitoring session. Stated another way, during the device monitoring session, the currently active device that is providing the session data may change to a different user device 106 based on one or more conditions, such as but not limited connection data associated with the currently active device and one or more of the other user devices 106, location data associated with the currently active device and one or more of the other user devices 106, whether the device monitoring session is a workout-based session, and the like.

At 1804, connection data associated with one or more of the user devices is determined. In some examples, the monitoring service 164 may determine different connection data that indicates that the currently active device of the user devices 106 is experiencing one or more conditions that affect the ability to communicate with one or more other devices. According to some configurations, the connection data may also be associated with a low battery state (e.g., below 20%, 10%, 5%, . . . ) of the currently active device. When the connection data indicates that a different user device 106 can provide more reliable data and communication as compared to the current active device, a handoff event is determined to occur.

At 1806, location data associated with one or more of the user devices is determined. In some examples, the monitoring service 164 and/or location-based service 166 may determine that the location of the current active device has remained at the same location for a period of time, but that one or more of the other user devices 106 has been moving (e.g., towards the destination). When the location data indicates that a different user device 106 can provide more reliable location data and communication as compared to the current active device, a handoff event is determined to occur.

At 1810, a determination is made that a handoff event has occurred. When a handoff event has not occurred, the flow returns to 1802. When a handoff event has occurred, the flow moves to 1812.

At 1812, a different one of the user devices 106 is set to the currently active device. According to some examples, the monitoring service 164 may select the active device from the user devices 106 based on a most recent interaction with a user device 106, and/or connection, power, or location data.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, and/or components.

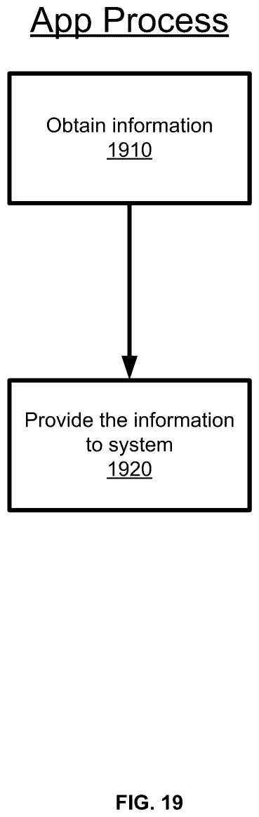

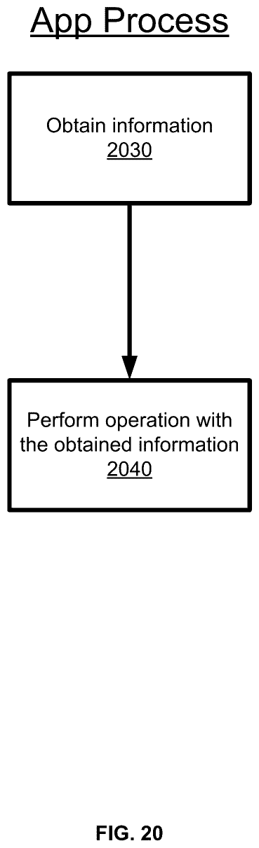

Implementations within the scope of the present disclosure include a computer-readable storage medium that encodes instructions organized as an application (e.g., application 2160) that, when executed by one or more processing units, control an electronic device (e.g., device 2150) to perform the method of FIG. 19, the method of FIG. 20, and/or one or more other processes and/or methods described herein.

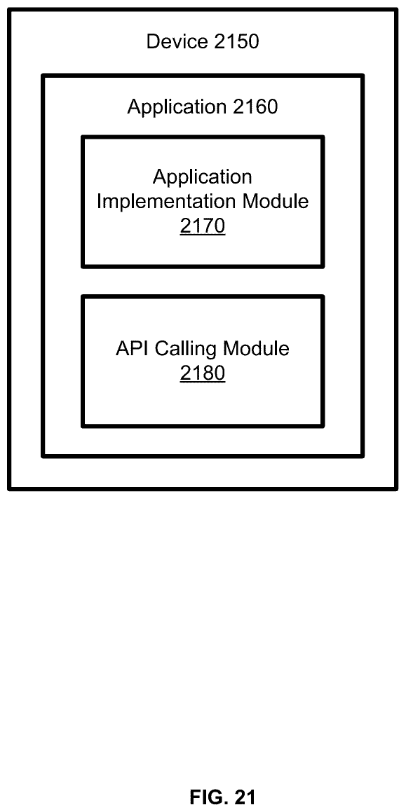

It should be recognized that application 2160 (shown in FIG. 21) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 2160 is an application that is pre-installed on device 2150 at purchase (e.g., a first party application). In other embodiments, application 2160 is an application that is provided to device 2150 via an operating system update file (e.g., a first party application or a second party application). In other embodiments, application 2160 is an application that is provided via an application store. In some embodiments, the application store can be an application store that is pre-installed on device 2150 at purchase (e.g., a first party application store). In other embodiments, the application store is a third-party application store (e.g., an application store that is provided by another application store, downloaded via a network, and/or read from a storage device).

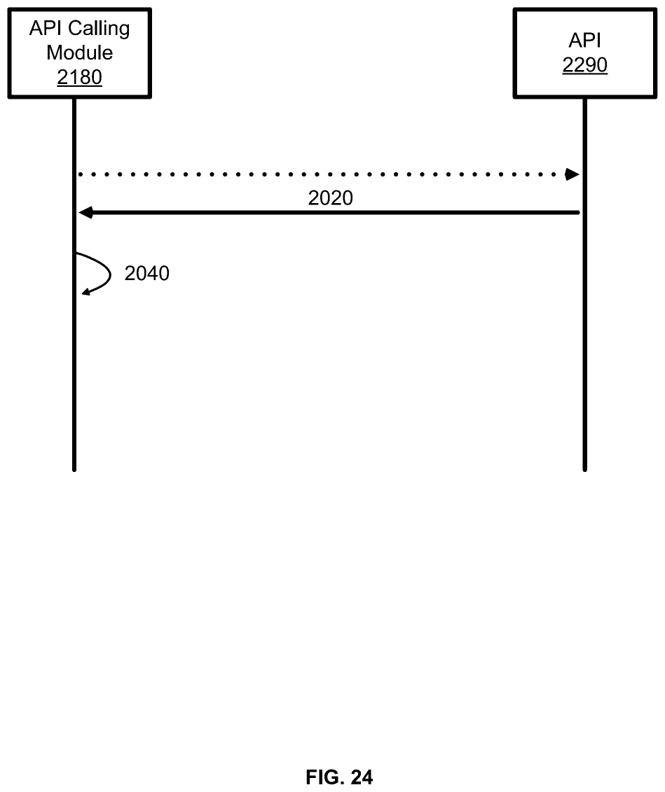

Referring to FIG. 19 and FIG. 24, application 2160 obtains information (e.g., 1910). In some embodiments, at 1910, information is obtained from at least one hardware component of the device 2150. In some embodiments, at 1910, information is obtained from at least one software module of the device 2150. In some embodiments, at 1910, information is obtained from at least one hardware component external to the device 2150 (e.g., a peripheral device, an accessory device, a server, etc.). In some embodiments, the information obtained at 1910 includes positional information, time information, notification information, user information, environment information, electronic device state information, weather information, media information, historical information, event information, hardware information, and/or motion information. In some embodiments, in response to and/or after obtaining the information at 1910, application 2160 provides the information to a system (e.g., 1920).

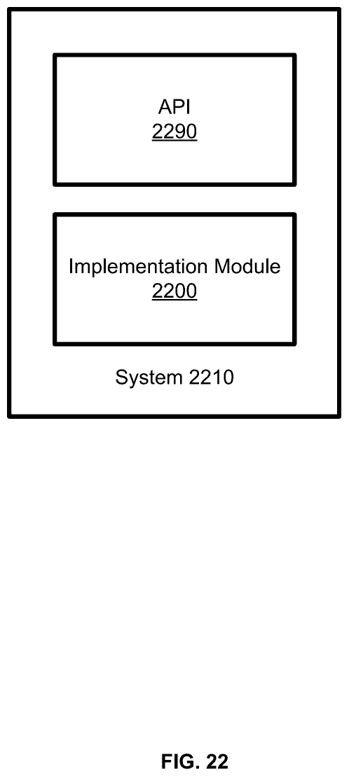

In some embodiments, the system (e.g., 2210 shown in FIG. 22) is an operating system hosted on the device 2150. In some embodiments, the system (e.g., 2210 shown in FIG. 22) is an external device (e.g., a server, a peripheral device, an accessory, a personal computing device, etc.) that includes an operating system.

Referring to FIG. 20 and FIG. 24, application 2160 obtains information (e.g., 2030). In some embodiments, the information obtained at 2030 includes positional information, time information, notification information, user information, environment information electronic device state information, weather information, media information, historical information, event information, hardware information and/or motion information. In response to and/or after obtaining the information at 2030, application 2160 performs an operation with the information (e.g., 2040). In some embodiments, the operation performed at 2040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 2210 based on the information.

In some embodiments, one or more steps of the method of FIG. 19 and/or the method of FIG. 20 is performed in response to a trigger. In some embodiments, the trigger includes detection of an event, a notification received from system 2210, a user input, and/or a response to a call to an API provided by system 2210.

In some embodiments, the instructions of application 2160, when executed, control device 2150 to perform the method of FIG. 19 and/or the method of FIG. 20 by calling an application programming interface (API) (e.g., API 2290) provided by system 2210. In some embodiments, application 2160 performs at least a portion of the method of FIG. 19 and/or the method of FIG. 20 without calling API 2290.

In some embodiments, one or more steps of the method of FIG. 19 and/or the method of FIG. 20 includes calling an API (e.g., API 2290) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 21, device 2150 is illustrated. In some embodiments, device 2150 is a personal computing device, a smart phone, a smart watch, a fitness tracker, a head mounted display (HMD) device, a media device, a communal device, a speaker, a television, and/or a tablet. As illustrated in FIG. 21, device 2150 includes application 2160 and operating system (e.g., system 2210 shown in FIG. 22). Application 2160 includes application implementation module 2170 and API calling module 2180. System 2210 includes API 2290 and implementation module 2200. It should be recognized that device 2150, application 2160, and/or system 2210 can include more, fewer, and/or different components than illustrated in FIGS. 21 and 22.

In some embodiments, application implementation module 2170 includes a set of one or more instructions corresponding to one or more operations performed by application 2160. For example, when application 2160 is a messaging application, application implementation module 2170 can include operations to receive and send messages. In some embodiments, application implementation module 2170 communicates with API calling module to communicate with system 2210 via API 2290 (shown in FIG. 22).

In some embodiments, API 2290 is a software module (e.g., a collection of computer-readable instructions) that provides an interface that allows a different module (e.g., API calling module 2180) to access and/or use one or more functions, methods, procedures, data structures, classes, and/or other services provided by implementation module 2200 of system 2210. For example, API-calling module 2180 can access a feature of implementation module 2200 through one or more API calls or invocations (e.g., embodied by a function or a method call) exposed by API 2290 and can pass data and/or control information using one or more parameters via the API calls or invocations. In some embodiments, API 2290 allows application 2160 to use a service provided by a Software Development Kit (SDK) library. In other embodiments, application 2160 incorporates a call to a function or method provided by the SDK library and provided by API 2290 or uses data types or objects defined in the SDK library and provided by API 2290. In some embodiments, API-calling module 2180 makes an API call via API 2290 to access and use a feature of implementation module 2200 that is specified by API 2290. In such embodiments, implementation module 2200 can return a value via API 2290 to API-calling module 2180 in response to the API call. The value can report to application 2160 the capabilities or state of a hardware component of device 2150, including those related to aspects such as input capabilities and state, output capabilities and state, processing capability, power state, storage capacity and state, and/or communications capability. In some embodiments, API 2290 is implemented in part by firmware, microcode, or other low level logic that executes in part on the hardware component.

In some embodiments, API 2290 allows a developer of API-calling module 2180 (which can be a third-party developer) to leverage a feature provided by implementation module 2200. In such embodiments, there can be one or more API-calling modules (e.g., including API-calling module 2180) that communicate with implementation module 2200. In some embodiments, API 2290 allows multiple API-calling modules written in different programming languages to communicate with implementation module 2200 (e.g., API 2290 can include features for translating calls and returns between implementation module 2200 and API-calling module 2180) while API 2290 is implemented in terms of a specific programming language. In some embodiments, API-calling module 2180 calls APIs from different providers such as a set of APIs from an OS provider, another set of APIs from a plug-in provider, and/or another set of APIs from another provider (e.g., the provider of a software library) or creator of the another set of APIs.

Examples of API 2290 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a bluetooth API, an NFC API, a UWB API, a fitness API, a smart home API, contact transfer API, photos API, camera API, and/or image processing API. In some embodiments the sensor API is an API for accessing data associated with a sensor of device 2150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation module 2200 is a system (e.g., operating system, server system) software module (e.g., a collection of computer-readable instructions) that is constructed to perform an operation in response to receiving an API call via API 2290. In some embodiments, implementation module 2200 is constructed to provide an API response (via API 2290) as a result of processing an API call. By way of example, implementation module 2200 and API-calling module 180 can each be any one of an operating system, a library, a device driver, an API, an application program, or other module. It should be understood that implementation module 2200 and API-calling module 2180 can be the same or different type of module from each other. In some embodiments, implementation module 2200 is embodied at least in part in firmware, microcode, or other hardware logic.

In some embodiments, implementation module 2200 returns a value through API 2290 in response to an API call from API-calling module 2180. While API 2290 defines the syntax and result of an API call (e.g., how to invoke the API call and what the API call does), API 2290 might not reveal how implementation module 2200 accomplishes the function specified by the API call. Various API calls are transferred via the one or more application programming interfaces between API-calling module 2180 and implementation module 2200. Transferring the API calls can include issuing, initiating, invoking, calling, receiving, returning, and/or responding to the function calls or messages. In other words, transferring can describe actions by either of API-calling module 2180 or implementation module 2200. In some embodiments, a function call or other invocation of API 2290 sends and/or receives one or more parameters through a parameter list or other structure.

In some embodiments, implementation module 2200 provides more than one API, each providing a different view of or with different aspects of functionality implemented by implementation module 2200. For example, one API of implementation module 2200 can provide a first set of functions and can be exposed to third party developers, and another API of implementation module 2200 can be hidden (e.g., not exposed) and provide a subset of the first set of functions and also provide another set of functions, such as testing or debugging functions which are not in the first set of functions. In some embodiments, implementation module 2200 calls one or more other components via an underlying API and thus be both an API calling module and an implementation module. It should be recognized that implementation module 2200 can include additional functions, methods, classes, data structures, and/or other features that are not specified through API 2290 and are not available to API calling module 2180. It should also be recognized that API calling module 2180 can be on the same system as implementation module 2200 or can be located remotely and access implementation module 2200 using API 2290 over a network. In some embodiments, implementation module 2200, API 2290, and/or API-calling module 2180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

In some embodiments, method 500 (FIG. 5), and/or other methods described herein, is performed at a first computer system (as described herein) via a system process (e.g., an operating system process, a server system process) that is different from one or more applications executing and/or installed on the first computer system. In some configurations, the instructions of the application, when executed, control the first computer system to perform method 500 (FIG. 5) by calling an application programming interface (API) provided by the system process. In some embodiments, the application performs at least a portion of method 500 without calling the API.

In some embodiments, the application can be any suitable type of application, including, for example, one or more of: a messaging application, a safety application, a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first party application). In other embodiments, the application is an application that is provided to the first computer system via an operating system update file (e.g., a first party application). In other embodiments, the application is an application that is provided via an application store. In some implementations, the application store is pre-installed on the first computer system at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the first computer system to perform method 500 (FIG. 5) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a bluetooth API, an NFC API, a UWB API, a fitness API, a smart home API, contact transfer API, photos API, camera API, and/or image processing API.

In some embodiments, at least one API is a software module (e.g., a collection of computer-readable instructions) that provides an interface that allows a different module (e.g., API calling module) to access and use one or more functions, methods, procedures, data structures, classes, and/or other services provided by an implementation module of the system process.

The API can define one or more parameters that are passed between the API calling module and the implementation module. In some embodiments, the API 2290 defines a first API call that can be provided by API calling module 2290, wherein the definition for the first API call specifies call parameters that are associated with a device monitoring session. In some examples, the call parameters may identify one or more devices, identify a type of device monitoring session, indicate a request for information (e.g., current location, anticipated location, . . . ), and the like. The implementation module is an system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 2150) that runs the application. In some embodiments, the implementation module is included in an electronic device that is separate from the device that runs the application.

As described above, one aspect of the present technology is the gathering and use of data available from various sources to perform device monitoring to determine a safety of a user. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, date of birth, or any other identifying or personal information.

The present disclosure recognizes that the use of such personal information data, in the present technology, can be used to the benefit of users. For example, the personal information data can be used to determine whether a user is safe or not. Accordingly, use of such personal information data enables a user to share information that may help them during a time of need.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of device monitoring sessions associated with a safety of a user, the present technology can be configured to allow users to select to “opt in” or “opt out” of participation in the collection of personal information data (or some portion of their personal information data) during registration for services or anytime thereafter. In another example, users can select not to provide personal information data for the purposes of performing a device monitoring session. In yet another example, users can select to limit the length of time personal information data is maintained or entirely prohibit the use of the personal information. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

The specification and drawings are to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the techniques to the specific form or forms disclosed, but on the contrary, the intention is to cover all modifications, alternative constructions and equivalents falling within the spirit and scope of the techniques, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order. The use of any and all examples, or exemplary language (e.g., “such as”) provided herein, is intended merely to better illuminate embodiments and does not pose a limitation on the scope of the techniques unless otherwise claimed. No language in the specification should be construed as indicating any non-claimed element as essential to the practice of the techniques.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known to the inventors for carrying out the techniques. Variations of those preferred embodiments may become apparent to those of ordinary skill in the art upon reading the foregoing description. The inventors expect skilled artisans to employ such variations as appropriate and the inventors intend for the techniques to be practiced otherwise than as specifically described herein. Accordingly, these techniques include all modifications and equivalents of the subject matter recited in the claims appended hereto as permitted by applicable law. Moreover, any combination of the above-described elements in all possible variations thereof is encompassed by the disclosed techniques unless otherwise indicated herein or otherwise clearly contradicted by context.

All references, including publications, patent applications and patents, cited herein are hereby incorporated by reference to the same extent as if each reference were individually and specifically indicated to be incorporated by reference and were set forth in its entirety herein.

1. A method, comprising:
receiving, from a first user device, an indication to start a device monitoring session;
sending, to a second user device, a first message that indicates a start of the device monitoring session;
gathering session data at different times throughout the device monitoring session, wherein the session data includes location data and other device data associated with the first user device;
generating, using a key associated with the first user device, encrypted session data from the session data;
storing the encrypted session data within a secure storage service that is separate from the first user device and the second user device;
monitoring, during the device monitoring session, the first user device to identify an occurrence of one or more events, wherein the one or more events include at least one of an end session event, a check-in event, or an anomaly event; and
performing one or more actions, based at least in part on the occurrence of the one or more events, wherein the one or more actions include at least one of an end session action that sends an end session message to the second user device that the session completed successfully, a check-in action that sends a check-in message to the first user device that requests an indication to continue or end the device monitoring session, or a release session data action that includes sending a release session data message to the second user device indicating that the second user device is authorized to access the encrypted session data from the secure storage service.

2. The method of claim 1, wherein the release session data message includes one or more of a decrypt key to decrypt the encrypted session data or an access token to access the encrypted session data stored in the secure storage service.

3. The method of claim 1, further comprising:
receiving, from the second user device, a request to release the encrypted session data; and
releasing the encrypted session data to the second user device based at least in part on an access token received from the second user device, or after a specified release time.

4. The method of claim 1, wherein the secure storage service uses an access token to protect access to the encrypted session data.

5. The method of claim 1, further comprising:
scheduling a release time to deliver the release session data message, wherein the scheduling is performed in advance of a determination to release the session data; and
updating the release time to deliver the release session data message based, at least in part, on a use of the first user device during the device monitoring session.

6. The method of claim 5, further comprising:
determining that the first user device is offline, and
sending the release session data message based, at least in part, on the determination that the first user device is offline and the release time.

7. The method of claim 1, further comprising:
determining that the first user device initiated an emergency call, and
sending the release session data message based, at least in part, on the determination that the first user device completed the emergency call.

8. The method of claim 1, wherein performing the one or more actions comprises sending the check-in message to the second user device based, at least in part, on determining that the first user device has been inactive for a predetermined period of time.

9. The method of claim 1, further comprising:
sending the check-in message to the first user device; and
sending the release session data message based, at least in part, on not receiving a reply to the check-in message within a predetermined time period.

10. The method of claim 1, further comprising generating a suggestion to start the device monitoring session based at least in part on at least one of one or more previous messages received by the first user device and sent by the second user device, one or more previous messages sent by the first user device, a current location, a current time, a desired destination, or a mode of transportation.

11. The method of claim 1, further comprising generating a suggestion to start the device monitoring session based at least in part on one or more keywords, one or more family contacts, or one or more emergency contacts.

12. The method of claim 1, further comprising sending the check-in message to the first user device, wherein the check-in message requests an input to indicate to continue the device monitoring session or end the device monitoring session.

13. The method of claim 1, further comprising sending the release session data message based at least in part on determining that a period of time elapsed since sending the check-in message and no response has been received that indicates to extend or end the device monitoring session.

14. The method of claim 10, further comprising sending the release session data message based at least in part on determining that the first user device is moving farther away from the desired destination.

15. The method of claim 1, further comprising periodically re-scheduling the release session data message to be delivered at a future time based at least in part on one or more of a network connectivity of the first user device, or a use of the first user device.

16. The method of claim 10, further comprising releasing the session data to the second user device, wherein the session data includes one or more previous locations of the first user device, a last known location of the first user device, the desired destination of the first user device, device usage data, a battery level of the first user device, or a connectivity status of the first user device.

17. The method of claim 1, further comprising sending the release session data message based at least in a determination that the first user device has deviated from a pattern.

18. The method of claim 10, further comprising:
determining a check-in time to send the check-in message based, at least in part, on an estimated travel time to the desired destination; and
updating the check-in time based, at least in part, on a use of the first user device.

19. The method of claim 1, further comprising monitoring a third device that is associated with a first user device based, at least in part, on the third device losing a wireless connection to the first user device.

20. The method of claim 10, further comprising determining a delay in moving toward the desired destination based, at least in part, on an updated estimated time of arrival at the desired destination.

21. The method of claim 1, further comprising performing end-to-end encryption for messages sent between the first user device and the second user device.

22. A system, comprising one or more memories storing computer-executable instructions and one or more processors in communication with the one or more memories, the one or more processors configured to execute the computer-executable instructions stored on the one or more memories to perform actions comprising:
receiving, from a first user device, an indication to start a device monitoring session;
sending, to a second user device, a first message that indicates a start of the device monitoring session;
gathering session data at different times throughout the device monitoring session, wherein the session data includes location data and other device data associated with the first user device;
generating, using a key associated with the first user device, encrypted session data from the session data;
storing the encrypted session data within a secure storage service that is separate from the first user device and the second user device;
monitoring, during the device monitoring session, the first user device to identify an occurrence of one or more events, wherein the one or more events include at least one of an end session event, a check-in event, or an anomaly event; and
performing one or more actions, based at least in part on the occurrence of the one or more events, wherein the one or more actions include at least one of an end session action that sends an end session message to the second user device that the session completed successfully, a check-in action that sends a check-in message to the first user device that requests an indication to continue or end the device monitoring session, or a release session data action that includes sending a release session data message to the second user device indicating that the second user device is authorized to access the encrypted session data from the secure storage service.

23. A computer-readable storage medium storing computer-executable instructions that, when executed by one or more processors of a computing device, configure the one or more processors to perform instructions to perform actions, comprising:
receiving, from a first user device, an indication to start a device monitoring session;
sending, to a second user device, a first message that indicates a start of the device monitoring session;
gathering session data at different times throughout the device monitoring session, wherein the session data includes location data and other device data associated with the first user device;
generating, using a key associated with the first user device, encrypted session data from the session data;
storing the encrypted session data within a secure storage service that is separate from the first user device and the second user device;
monitoring, during the device monitoring session, the first user device to identify an occurrence of one or more events, wherein the one or more events include at least one of an end session event, a check-in event, or an anomaly event; and
performing one or more actions, based at least in part on the occurrence of the one or more events, wherein the one or more actions include at least one of an end session action that sends an end session message to the second user device that the session completed successfully, a check-in action that sends a check-in message to the first user device that requests an indication to continue or end the device monitoring session, or a release session data action that includes sending a release session data message to the second user device indicating that the second user device is authorized to access the encrypted session data from the secure storage service.

24-60. (canceled)
